(19) United States
(12) Patent Application Publication
(10) Pub. No.: US 2025/0287294 A1
(43) Pub. Date: Sep. 11, 2025

(54) METHODS AND APPARATUSES FOR EDGE APPLICATION SERVICE

(71) Applicant: TELEFONAKTIEBOLAGET LM ERICSSON (PUBL), Stockholm (SE)

(72) Inventors: Wenliang XU, SHANGHAI (CN); Maria Luisa MAS ROSIQUE, Tres Cantos (ES); Fuencisla GARCIA AZORERO, MADRID (ES)

(21) Appl. No.: 18/682,433

(22) PCT Filed: Jul. 29, 2022
(86) PCT No.: PCT/CN2022/108911

§ 371 Date: Feb. 8, 2024

(30) Foreign Application Priority Data
Aug. 9, 2021 (WO) PCT/CN2021/111634

(51) Int. Cl. H04W 48/16; H04W 8/18; H04W 8/20; H04W 12/06

(52) U.S. Cl. CPC H04W 48/16; H04W 8/183; H04W 8/20; H04W 12/06

(57) ABSTRACT

Methods and apparatuses for edge application service are disclosed. According to an embodiment, an application function (AF) sends, to a network exposure function (NEF), a request for performing an operation related to edge application server (EAS) deployment information for an application. The request is for creating, or updating, or deleting EAS deployment information. The AF receives, from the NEF, a response to the request.

### TECHNICAL FIELD

Embodiments of the disclosure generally relate to communication, and, more particularly, to methods and apparatuses for edge application service.

### BACKGROUND

This section introduces aspects that may facilitate better understanding of the present disclosure. Accordingly, the statements of this section are to be read in this light and are not to be understood as admissions about what is in the prior art or what is not in the prior art.

FIG. 1 illustrates the 5th generation (5G) architecture for non-roaming supporting edge computing (with uplink (UL) classifier (CL)/branching point (BP)). The edge application server (EAS) discovery function (EASDF) network function (NF) defined for the architecture supporting edge computing has the capability to influence the domain name system (DNS) query of an edge application so that the EAS discovery considers a candidate user equipment (UE) topological location of a protocol data unit (PDU) session anchor (PSA) further out (more suitable) in the network than the current PSA.

The EASDF includes e.g. the following functionalities: handling the DNS messages according to the instruction from the session management function (SMF), including receiving DNS message handling rules from SMF, exchanging DNS messages from the UE, forwarding DNS messages to central DNS (C-DNS) or local DNS (L-DNS) for DNS query, adding extension mechanisms for DNS (EDNS) client subnet (ECS) option into DNS query for a fully qualified domain name (FQDN), and notifying EASDF related information to SMF; and terminating the DNS security, if used.

The instructions the SMF provides to the EASDF about how to deal with DNS messages depend on how the edge applications are deployed in the different available/applicable edges. That is, the EAS discovery procedure enabled by EASDF depends on the availability of EAS deployment information in the 5G core network (5GC).

In edge computing deployment, an application service may be served by multiple edge application servers typically deployed in different sites. These multiple edge application servers that host the application service may use a single Internet protocol (IP) address (anycast address) or different IP addresses. To start an edge application service, the UE needs to know the IP address(es) of the application server(s) serving the service at that edge. The UE may do a discovery to get the IP address(es) of a suitable edge application server (e.g. the closest one), so that the traffic can be locally routed to the edge application server and service latency, traffic routing path and user service experience can be optimized.

EAS discovery is the procedure by which a UE discovers the IP address(es) of a suitable edge application server(s) using DNS. EAS Re-discovery is the EAS Discovery procedure that takes place when the previously discovered edge application server cannot be used or may have become non-optimal (e.g. at edge relocation) and a new edge application server needs to be used.

DNS server may be deployed in different locations in the network as C-DNS resolver/server or as L-DNS resolver/server. In order to provide a translation of the FQDN of an EAS into the address of an EAS as topologically close as possible to the UE, the DNS may use following information: the source IP address of the incoming DNS query; and/or an EDNS Client Subnet (ECS) option (as defined in request for comments (RFC) 7871). If the UE applications want to discover/access EAS by using the mechanisms defined in this 3rd generation partnership project (3GPP) technical specification (TS) 23.548 V 1.0.0, the DNS queries generated by the UE shall be sent to the EASDF as DNS resolver indicated by the SMF.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for edge application service. In particular, one of the problems to be solved by the disclosure is that the existing solution for provisioning EAS deployment information may be problematic in terms of required bandwidth and implementation complexity.

According to a first aspect of the disclosure, there is provided a method performed by an application function (AF). The method may comprise sending, to a network exposure function (NEF), or a policy control function (PCF), an indicator indicating whether an application associated with the AF requires edge application server (EAS) discovery supported by EAS discovery function (EASDF).

In this way, it is possible to reduce required bandwidth and implementation complexity for provisioning EAS deployment information.

In an embodiment of the disclosure, the indicator may be sent to the NEF in a request for influencing traffic routing for the application.

In an embodiment of the disclosure, the request may be an Nnef_TrafficInfluence_Create Request or Nnef_TrafficInfluence_Update Request.

In an embodiment of the disclosure, the indicator may be sent to the PCF in a request for creating or updating a policy for a protocol data unit (PDU) session associated with the application.

In an embodiment of the disclosure, the request may be an Npcf_PolicyAuthorization_Create Request or Npcf_PolicyAuthorization_Update Request.

According to a second aspect of the disclosure, there is provided a method performed by an NEF. The method may comprise obtaining an indicator indicating whether an application associated with an AF requires EAS discovery supported by EASDF.

In this way, it is possible to reduce required bandwidth and implementation complexity for provisioning EAS deployment information.

In an embodiment of the disclosure, obtaining the indicator may comprise receiving the indicator from the AF.

In an embodiment of the disclosure, obtaining the indicator may comprise receiving, from the AF, information for deriving the indicator. Obtaining the indicator may further comprise determining the indicator based on the received information.

In an embodiment of the disclosure, the information for deriving the indicator may be an identifier identifying the application.

In an embodiment of the disclosure, the indicator or the information for deriving the indicator may be received from the AF in a request for influencing traffic routing for the application.

In an embodiment of the disclosure, the request may be an Nnef_TrafficInfluence_Create Request or Nnef_TrafficInfluence_Update Request.

In an embodiment of the disclosure, the method may further comprise sending the obtained indicator to a user data repository (UDR) or a policy control function (PCF).

In an embodiment of the disclosure, the obtained indicator may be sent to the PCF in a request for creating or updating a policy for a PDU session associated with the application.

In an embodiment of the disclosure, the request may be an Npcf_PolicyAuthorization_Create Request or Npcf_PolicyAuthorization_Update Request.

According to a third aspect of the disclosure, there is provided a method performed by a UDR. The method may comprise receiving, from an NEF, an indicator indicating whether an application associated with an AF requires EAS discovery supported by EASDF. The method may further comprise maintaining the received indicator.

In this way, it is possible to reduce required bandwidth and implementation complexity for provisioning EAS deployment information.

In an embodiment of the disclosure, the method may further comprise, when a PCF has subscribed to a change of traffic influence requested by the AF for the application, sending the indicator to the PCF.

According to a fourth aspect of the disclosure, there is provided a method performed by a PCF. The method may comprise receiving, from a UDR or an AF or an NEF, an indicator indicating whether an application associated with the AF requires EAS discovery supported by EASDF.

In this way, it is possible to reduce required bandwidth and implementation complexity for provisioning EAS deployment information.

In an embodiment of the disclosure, the indicator may be received from the AF or the NEF in a request for creating or updating a policy for a PDU session associated with the application.

In an embodiment of the disclosure, the request may be an Npcf_PolicyAuthorization_Create Request or Npcf_PolicyAuthorization_Update Request.

In an embodiment of the disclosure, the method may further comprise sending the received indicator to a session management function (SMF).

In an embodiment of the disclosure, the received indicator may be sent to the SMF in a request for notifying updated policy information for a PDU session associated with the application.

In an embodiment of the disclosure, the request may be an Npcf_SMPolicyControl_UpdateNotify Request.

According to a fifth aspect of the disclosure, there is provided a method performed by an SMF. The method may comprise receiving, from a PCF, an indicator indicating whether an application associated with an AF requires EAS discovery supported by EASDF.

In this way, it is possible to reduce required bandwidth and implementation complexity for provisioning EAS deployment information.

In an embodiment of the disclosure, the indicator may be received from the PCF in a request for notifying updated policy information for a PDU session associated with the application.

In an embodiment of the disclosure, the request may be an Npcf_SMPolicyControl_UpdateNotify Request.

In an embodiment of the disclosure, the method may further comprise, when the indicator indicates that the application associated with the AF requires EAS discovery supported by EASDF, obtaining, from an NEF, EAS deployment information for the application.

In an embodiment of the disclosure, the method may further comprise, when the indicator indicates that the application associated with the AF requires EAS discovery supported by EASDF, deferring an enforcement of user plane (UP) path change to a reception of a notification from the EASDF notifying a usable EAS.

According to a sixth aspect of the disclosure, there is provided a method performed by a service consumer. The method may comprise sending, to an NEF, a request for performing an operation related to EAS deployment information for an application. The method may further comprise receiving, from the NEF, a response to the request.

In this way, it is possible to reduce required bandwidth and implementation complexity for provisioning EAS deployment information.

In an embodiment of the disclosure, the service consumer may be an AF associated with the application.

In an embodiment of the disclosure, the request may be for creating, or updating, or deleting EAS deployment information for the application.

In an embodiment of the disclosure, the request may be an Nnef_EASDeployment_Create/Update/Delete Request.

In an embodiment of the disclosure, the service consumer may be an SMF.

In an embodiment of the disclosure, the request may be for subscribing or unsubscribing a notification of a change of EAS deployment information, or for notifying the EAS deployment information.

In an embodiment of the disclosure, the request may be an Nnef_EASDeployment_Subscribe/Unsubscribe/Notify Request.

According to a seventh aspect of the disclosure, there is provided a method performed by an AF. The method may comprise sending, to an NEF, a request for performing an operation related to EAS deployment information for an application. The request may be for creating, or updating, or deleting EAS deployment information. The method may further comprise receiving, from the NEF, a response to the request.

In this way, it is possible to reduce required bandwidth and implementation complexity for provisioning EAS deployment information.

In an embodiment of the disclosure, the request may be an Nnef_EASDeployment_Create/Update/Delete Request.

According to an eighth aspect of the disclosure, there is provided a method performed by an NEF. The method may comprise receiving, from a service consumer, a request for performing an operation related to EAS deployment information for an application. The method may further comprise sending, to the service consumer, a response to the request.

In this way, it is possible to reduce required bandwidth and implementation complexity for provisioning EAS deployment information.

In an embodiment of the disclosure, the service consumer may be an AF associated with the application.

In an embodiment of the disclosure, the request may be for creating, or updating, or deleting EAS deployment information for the application.

In an embodiment of the disclosure, the request may be an Nnef_EASDeployment_Create/Update/Delete Request.

In an embodiment of the disclosure, the service consumer may be an SMF.

In an embodiment of the disclosure, the request may be for subscribing or unsubscribing a notification of a change of EAS deployment information, or for notifying the EAS deployment information.

In an embodiment of the disclosure, the request may be an Nnef_EASDeployment_Subscribe/Unsubscribe/Notify Request.

According to a ninth aspect of the disclosure, there is provided a method performed by an NEF. The method may comprise receiving, from an AF, a request for performing an operation related to EAS deployment information for an application. The request may be for creating, or updating, or deleting EAS deployment information. The method may further comprise checking whether the AF is authorized to perform the request. The method may further comprise, if the AF is authorized, sending, to a UDR, another request for creating, or updating, or deleting EAS deployment information. The method may further comprise sending, to the AF, a response to the request.

In this way, it is possible to reduce required bandwidth and implementation complexity for provisioning EAS deployment information.

In an embodiment of the disclosure, the request may be an Nnef_EASDeployment_Create/Update/Delete Request.

In an embodiment of the disclosure, the method may further comprise receiving, from an SMF, a Nnef_EASDeployment_Subscribe request for subscribing the EAS deployment information change notification. The request may indicate that current status of the EAS deployment information shall be notified immediately.

In an embodiment of the disclosure, the method may further comprise sending, to the SMF, a Nnef_EASDeployment_Notify message including the EAS deployment information.

According to a tenth aspect of the disclosure, there is provided a method performed by a UDR. The method may comprise receiving, from an NEF, a request for performing an operation related to EAS deployment information for an application. The method may further comprise sending, to the NEF, a response to the request.

In this way, it is possible to reduce required bandwidth and implementation complexity for provisioning EAS deployment information.

In an embodiment of the disclosure, the request may be for creating, or updating, or deleting EAS deployment information for the application.

In an embodiment of the disclosure, the request may be an Nudr_DM_Create/Update/Delete Request.

According to an eleventh aspect of the disclosure, there is provided a method performed by a UDR. The method may comprise receiving, from an NEF, a request for performing an operation related to EAS deployment information for an application. The request may be for creating, or updating, or deleting EAS deployment information for the application. The method may further comprise storing or updating or removing the corresponding EAS deployment information in response to the request from the NEF. The method may further comprise sending, to the NEF, a response to the request.

In this way, it is possible to reduce required bandwidth and implementation complexity for provisioning EAS deployment information.

In an embodiment of the disclosure, the request may be an Nudr_DM_Create/Update/Delete Request.

According to a twelfth aspect of the disclosure, there is provided an AF. The AF may comprise at least one processor and at least one memory. The at least one memory may contain instructions executable by the at least one processor, whereby the AF may be operative to send, to an NEF or a PCF, an indicator indicating whether an application associated with the AF requires EAS discovery supported by EASDF.

In an embodiment of the disclosure, the AF may be operative to perform the method according to the above first aspect.

According to a thirteenth aspect of the disclosure, there is provided an NEF. The NEF may comprise at least one processor and at least one memory. The at least one memory may contain instructions executable by the at least one processor, whereby the NEF may be operative to obtain an indicator indicating whether an application associated with an AF requires EAS discovery supported by EASDF.

In an embodiment of the disclosure, the NEF may be operative to perform the method according to the above second aspect.

According to a fourteenth aspect of the disclosure, there is provided a UDR. The UDR may comprise at least one processor and at least one memory. The at least one memory may contain instructions executable by the at least one processor, whereby the UDR may be operative to receive, from an NEF, an indicator indicating whether an application associated with an AF requires EAS discovery supported by EASDF. The UDR may be further operative to maintain the received indicator.

In an embodiment of the disclosure, the UDR may be operative to perform the method according to the above third aspect.

According to a fifteenth aspect of the disclosure, there is provided a PCF. The PCF may comprise at least one processor and at least one memory. The at least one memory may contain instructions executable by the at least one processor, whereby the PCF may be operative to receive, from a UDR or an AF or an NEF, an indicator indicating whether an application associated with the AF requires EAS discovery supported by EASDF.

In an embodiment of the disclosure, the PCF may be operative to perform the method according to the above fourth aspect.

According to a sixteenth aspect of the disclosure, there is provided an SMF. The SMF may comprise at least one processor and at least one memory. The at least one memory may contain instructions executable by the at least one processor, whereby the SMF may be operative to receive, from a PCF, an indicator indicating whether an application associated with an AF requires EAS discovery supported by EASDF.

In an embodiment of the disclosure, the SMF may be operative to perform the method according to the above fifth aspect.

According to a seventeenth aspect of the disclosure, there is provided a service consumer. The service consumer may comprise at least one processor and at least one memory. The at least one memory may contain instructions executable by the at least one processor, whereby the service consumer may be operative to send, to an NEF, a request for performing an operation related to EAS deployment information for an application. The service consumer may be further operative to receive, from the NEF, a response to the request.

In an embodiment of the disclosure, the service consumer may be operative to perform the method according to the above sixth aspect.

According to an eighteenth aspect of the disclosure, there is provided an AF. The AF may comprise at least one processor and at least one memory. The at least one memory may contain instructions executable by the at least one processor, whereby the AF may be operative to send, to an NEF, a request for performing an operation related to EAS deployment information for an application. The request may be for creating, or updating, or deleting EAS deployment information. The AF may be further operative to receive, from the NEF, a response to the request.

In an embodiment of the disclosure, the AF may be operative to perform the method according to the above seventh aspect.

According to a nineteenth aspect of the disclosure, there is provided an NEF. The NEF may comprise at least one processor and at least one memory. The at least one memory may contain instructions executable by the at least one processor, whereby the NEF may be operative to receive, from a service consumer, a request for performing an operation related to EAS deployment information for an application. The NEF may be further operative to send, to the service consumer, a response to the request.

In an embodiment of the disclosure, the NEF may be operative to perform the method according to the above eighth aspect.

According to a twentieth aspect of the disclosure, there is provided an NEF. The NEF may comprise at least one processor and at least one memory. The at least one memory may contain instructions executable by the at least one processor, whereby the NEF may be operative to receive, from an AF, a request for performing an operation related to EAS deployment information for an application. The request may be for creating, or updating, or deleting EAS deployment information. The NEF may be further operative to check whether the AF is authorized to perform the request. The NEF may be further operative to, if the AF is authorized, send, to a UDR, another request for creating, or updating, or deleting EAS deployment information. The NEF may be further operative to send, to the AF, a response to the request.

In an embodiment of the disclosure, the NEF may be operative to perform the method according to the above ninth aspect.

According to a twenty-first aspect of the disclosure, there is provided a UDR. The UDR may comprise at least one processor and at least one memory. The at least one memory may contain instructions executable by the at least one processor, whereby the UDR may be operative to receive, from an NEF, a request for performing an operation related to EAS deployment information for an application. The UDR may be further operative to send, to the NEF, a response to the request.

In an embodiment of the disclosure, the UDR may be operative to perform the method according to the above tenth aspect.

According to a twenty-second aspect of the disclosure, there is provided a UDR. The UDR may comprise at least one processor and at least one memory. The at least one memory may contain instructions executable by the at least one processor, whereby the UDR may be operative to receive, from an NEF, a request for performing an operation related to EAS deployment information for an application. The request may be for creating, or updating, or deleting EAS deployment information for the application. The UDR may be further operative to store or update or remove the corresponding EAS deployment information in response to the request from the NEF. The UDR may be further operative to send, to the NEF, a response to the request.

In an embodiment of the disclosure, the UDR may be operative to perform the method according to the above eleventh aspect.

According to a twenty-third aspect of the disclosure, there is provided a computer program product. The computer program product may contain instructions which when executed by at least one processor, cause the at least one processor to perform the method according to any of the above first to eleventh aspects.

According to a twenty-fourth aspect of the disclosure, there is provided a computer readable storage medium. The computer readable storage medium may store thereon instructions which when executed by at least one processor, cause the at least one processor to perform the method according to any of the above first to eleventh aspects.

According to a twenty-fifth aspect of the disclosure, there is provided an AF. The AF may comprise a sending module for sending, to an NEF or a PCF, an indicator indicating whether an application associated with the AF requires EAS discovery supported by EASDF.

According to a twenty-sixth aspect of the disclosure, there is provided an NEF. The NEF may comprise an obtaining module for obtaining an indicator indicating whether an application associated with an AF requires EAS discovery supported by EASDF.

According to a twenty-seventh aspect of the disclosure, there is provided a UDR. The UDR may comprise a reception module for receiving, from an NEF, an indicator indicating whether an application associated with an AF requires EAS discovery supported by EASDF. The UDR may further comprise a maintaining module for maintaining the received indicator.

According to a twenty-eighth aspect of the disclosure, there is provided a PCF. The PCF may comprise a reception module for receiving, from a UDR or an AF or an NEF, an indicator indicating whether an application associated with the AF requires EAS discovery supported by EASDF.

According to a twenty-ninth aspect of the disclosure, there is provided an SMF. The SMF may comprise a reception module for receiving, from a PCF, an indicator indicating whether an application associated with an AF requires EAS discovery supported by EASDF.

According to a thirtieth aspect of the disclosure, there is provided a service consumer. The service consumer may comprise a sending module for sending, to an NEF, a request for performing an operation related to EAS deployment information for an application. The service consumer may further comprise a reception module for receiving, from the NEF, a response to the request.

According to a thirty-first aspect of the disclosure, there is provided an AF. The AF may comprise a sending module for sending, to an NEF, a request for performing an operation related to EAS deployment information for an application. The request may be for creating, or updating, or deleting EAS deployment information. The AF may further comprise a reception module for receiving, from the NEF, a response to the request.

According to a thirty-second aspect of the disclosure, there is provided an NEF. The NEF may comprise a reception module for receiving, from a service consumer, a request for performing an operation related to EAS deployment information for an application. The NEF may further comprise a sending module for sending, to the service consumer, a response to the request.

According to a thirty-third aspect of the disclosure, there is provided an NEF. The NEF may comprise a reception module for receiving, from an AF, a request for performing an operation related to EAS deployment information for an application. The request may be for creating, or updating, or deleting EAS deployment information. The NEF may further comprise a checking module for checking whether the AF is authorized to perform the request. The NEF may further comprise a first sending module for, if the AF is authorized, sending, to a UDR, another request for creating, or updating, or deleting EAS deployment information. The NEF may further comprise a second sending module for sending, to the AF, a response to the request.

According to a thirty-fourth aspect of the disclosure, there is provided a UDR. The UDR may comprise a reception module for receiving, from an NEF, a request for performing an operation related to EAS deployment information for an application. The UDR may further comprise a sending module for sending, to the NEF, a response to the request.

According to a thirty-fifth aspect of the disclosure, there is provided a UDR. The UDR may comprise a reception module for receiving, from an NEF, a request for performing an operation related to EAS deployment information for an application. The request may be for creating, or updating, or deleting EAS deployment information for the application. The UDR may further comprise a control module for storing or updating or removing the corresponding EAS deployment information in response to the request from the NEF. The UDR may further comprise a sending module for sending, to the NEF, a response to the request.

According to a thirty-sixth aspect of the disclosure, there is provided a method implemented in a communication system including any two or more of the AF, the NEF, the UDR, the PCF and the SMF according to the above twelfth to sixteenth aspects or twenty-fifth to twenty-ninth aspects. The method may comprise all steps of the methods performed by any two or more of the AF, the NEF, the UDR, the PCF and the SMF.

According to a thirty-seventh aspect of the disclosure, there is provided a communication system. The communication system may comprise any two or more of the AF, the NEF, the UDR, the PCF and the SMF according to the above twelfth to sixteenth aspects or twenty-fifth to twenty-ninth aspects.

According to a thirty-eighth aspect of the disclosure, there is provided a method implemented in a communication system including any two or more of the service consumer, the NEF and the UDR according to the above seventeenth, nineteenth, and twenty-first aspects or according to the above thirtieth, thirty-second, and thirty-fourth aspects. The method may comprise all steps of the methods performed by any two or more of the service consumer, the NEF and the UDR.

According to a thirty-ninth aspect of the disclosure, there is provided a communication system. The communication system may comprise any two or more of the service consumer, the NEF and the UDR according to the above seventeenth, nineteenth, and twenty-first aspects or according to the above thirtieth, thirty-second, and thirty-fourth aspects.

According to a fortieth aspect of the disclosure, there is provided a method implemented in a communication system including any two or more of the AF, the NEF and the UDR according to the above eighteenth, twentieth, and twenty-second aspects or according to the above thirty-first, thirty-third, and thirty-fifth aspects. The method may comprise all steps of the methods performed by any two or more of the service consumer, the NEF and the UDR.

According to a forty-first aspect of the disclosure, there is provided a communication system. The communication system may comprise any two or more of the AF, the NEF and the UDR according to the above eighteenth, twentieth, and twenty-second aspects or according to the above thirty-first, thirty-third, and thirty-fifth aspects.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating the 5G architecture for non-roaming supporting edge computing;

FIG. 2 is a diagram illustrating an exemplary communication system into which an embodiment of the disclosure is applicable;

FIG. 3 is a flowchart illustrating a method performed by an AF according to an embodiment of the disclosure;

FIG. 4 is a flowchart illustrating a method performed by an NEF according to an embodiment of the disclosure;

FIG. 5 is a flowchart for explaining the method of FIG. 4;

FIG. 6 is a flowchart illustrating a method performed by an NEF according to an embodiment of the disclosure;

FIG. 7 is a flowchart illustrating a method performed by a UDR according to an embodiment of the disclosure;

FIG. 8 is a flowchart illustrating a method performed by an UDR according to an embodiment of the disclosure;

FIG. 9 is a flowchart illustrating a method performed by a PCF according to an embodiment of the disclosure;

FIG. 10 is a flowchart illustrating a method performed by a PCF according to an embodiment of the disclosure;

FIG. 11 is a flowchart illustrating a method performed by an SMF according to an embodiment of the disclosure;

FIG. 12 is a flowchart illustrating a method performed by an SMF according to an embodiment of the disclosure;

FIG. 13 is a flowchart illustrating a method performed by a service consumer according to an embodiment of the disclosure;

FIGS. 14A-14C are flowcharts each illustrating a method performed by an NEF according to an embodiment of the disclosure;

FIGS. 15A-15B are flowcharts each illustrating a method performed by an UDR according to an embodiment of the disclosure;

FIG. 16 is a flowchart illustrating an exemplary process according to an embodiment of the disclosure;

FIG. 17 is a flowchart illustrating an exemplary process according to an embodiment of the disclosure;

FIG. 18 is a flowchart illustrating an exemplary process according to an embodiment of the disclosure;

FIG. 19 is a flowchart illustrating an exemplary process according to an embodiment of the disclosure;

FIG. 20 is a flowchart illustrating an exemplary process according to an embodiment of the disclosure;

FIG. 21 is a block diagram showing an apparatus suitable for use in practicing some embodiments of the disclosure;

FIG. 22 is a block diagram showing an AF according to an embodiment of the disclosure;

FIG. 23 is a block diagram showing an NEF according to an embodiment of the disclosure;

FIG. 24 is a block diagram showing a UDR according to an embodiment of the disclosure;

FIG. 25 is a block diagram showing a PCF according to an embodiment of the disclosure;

FIG. 26 is a block diagram showing an SMF according to an embodiment of the disclosure;

FIG. 27 is a block diagram showing a service consumer according to an embodiment of the disclosure;

FIGS. 28A-28B are block diagrams each showing an NEF according to an embodiment of the disclosure; and

FIGS. 29A-29B are block diagrams each showing a UDR according to an embodiment of the disclosure;

FIG. 30 is diagram illustrating an example of a communication system in accordance with some embodiments;

FIG. 31 is a diagram illustrating a UE in accordance with some embodiments;

FIG. 32 is a diagram illustrating a network node in accordance with some embodiments;

FIG. 33 is a diagram illustrating a host in accordance with some embodiments;

FIG. 34 is a diagram illustrating a virtualization environment in which functions implemented by some embodiments may be virtualized; and

FIG. 35 is a diagram illustrating a host communicating via a network node with a UE over a partially wireless connection in accordance with some embodiments.

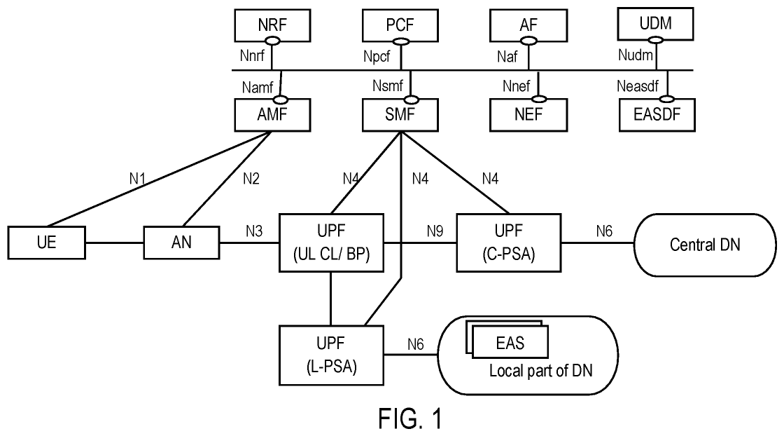

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The current solution specifies that the AF provisions EAS deployment information (the list of FQDNs supported by application servers for each data network access identifier (DNAI), the IP address range(s) corresponding to each application server for each DNAI and the DNS server identifier (consisting of IP address and port) for each DNAI) in the UDR as additional information to the information specified for AF influence on traffic routing, as specified in 3GPP TS 23.501 V 17.1.1, section 5.6.7.

3GPP defines a policy control and charging (PCC) architecture that allows handling Policy and Charging Control in the network. This architecture is defined in 3GPP TS 23.503 (5G) or TS 23.203 (EPS). For simplicity purpose, the description here is based on 5GC architecture. Similar technology exists in EPC as well. The PCF is a functional element that encompasses policy control decision and flow based charging control functionalities. The PCF provides network control regarding the service data flow detection, gating, quality of service (QOS) and flow based charging (except credit management) towards the SMF. The PCF receives session and media related information from the AF and informs AF of traffic plane events.

The PCF shall provision PCC Rules to the SMF via the N7 reference point. The PCF shall inform the SMF through the use of PCC rules on the treatment of each service data flow that is under PCC control, in accordance with the PCF policy decision(s). This treatment includes specific treatment for Edge Computing Applications. The SMF/UPF encompasses service data flow detection based on the filters definitions included in the PCC rules and policy enforcement.

The currently specified procedure requires that for each application service the EAS deployment information is provided in the PCC rule. Though it is a feasible option, it presents the following problems.

Firstly, the purpose of a PCC rule (provisioning of policy decisions that need to be enforced by the SMF) is totally distorted, since it would be providing general purpose EAS deployment information required by the SMF for the actual enforcement instruction the PCC rule is indicating. From the viewpoint of the inventors, from the PCC rule information, what should be enough is the indication that for a given application, EAS discovery supported by EASDF needs to be enforced “right now”. This is because the EAS deployment information should be available in the SMF, for any PDU session that might require it, independently.

Secondly, provision of the EAS deployment information within the PCC rule increases the required bandwidth for PCC rule provisioning. When several UEs access the same application servers, this increase of bandwidth is proportionally increasing to the number of PDU sessions being activated. Thirdly, efficient storage of EAS deployment information in the SMF increases as well in complexity.

The present disclosure proposes an improved solution for edge application service. The basic idea is to decouple the provisioning of the EAS deployment information from the provisioning of the PCC rule. Specifically, a new service may be defined (which may be called Nnef_EASDeployment) to enable an AF to create/update/delete EAS deployment information in the 5GC by interacting with the NEF, and to enable the SMF to subscribe (and retrieve the currently provisioned EAS deployment information), unsubscribe and be notified of EAS deployment changes. Correspondingly, application data for Edge Computing (AF traffic influence data) may be defined in UDR, to enable the storage of the provisioned EAS deployment information. With the new service, an SMF can be allowed to quickly and efficiently retrieve the EAS deployment information required to properly influence the DNS query so that the appropriate L-DNS and Local Edge can be determined for the requested UE traffic. In addition, it protects the 5GC network from creating duplicated resources by means of NEF implementing the conflict detection and providing accurate information to AF so that they can resolve the conflict based on needs/requirements, hence making the AF information and 5GC network information consistent after an AF failure.

An indication about whether indicated application requires edge computing EAS discovery related procedures (and thus interaction with the EASDF) may also be introduced in the AF influence on traffic routing data. For example, this indication may be derived from the NEF based on the received AF service identifier, and then, provisioned in the UDR or provided in the N5 interface, as applicable. The PCF may then include it in the related PCC rule. Since only the indication is included in the PCC rule, it can avoid extra bandwidth occupation in the PCC rule request/provisioning procedure, and in the extra storage capacity in the SMF.

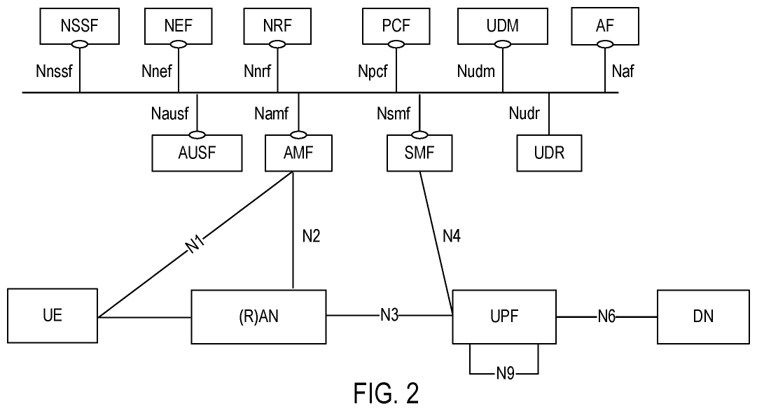

Hereinafter, the solution will be described in detail with reference to FIGS. 2-29. FIG. 2 is a diagram illustrating an exemplary communication system into which an embodiment of the disclosure is applicable. As shown, the communication system comprises a user equipment (UE), a (radio) access network ((R)AN), a user plane function (UPF), a data network (DN), an authentication server function (AUSF), an access and mobility management function (AMF), a session management function (SMF), a user data repository (UDR), a network slice selection function (NSSF), a network exposure function (NEF), a network repository function (NRF), a policy control function (PCF), a unified data management (UDM) and an application function (AF). The functional description of the above entities is specified in clause 6 of 3GPP TS 23.501 V 17.1.1, which is incorporated herein by reference in its entirety.

Note that within the context of this disclosure, the term UE or terminal device may also be referred to as, for example, device, access terminal, mobile station, mobile unit, subscriber station, or the like. It may refer to any end device that can access a wireless communication network and receive services therefrom. By way of example and not limitation, the UE or terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE or terminal device may represent a machine or other device that performs monitoring and/or measurements, and transmits the results of such monitoring and/or measurements to another UE or terminal device and/or a network equipment. In this case, the UE or terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

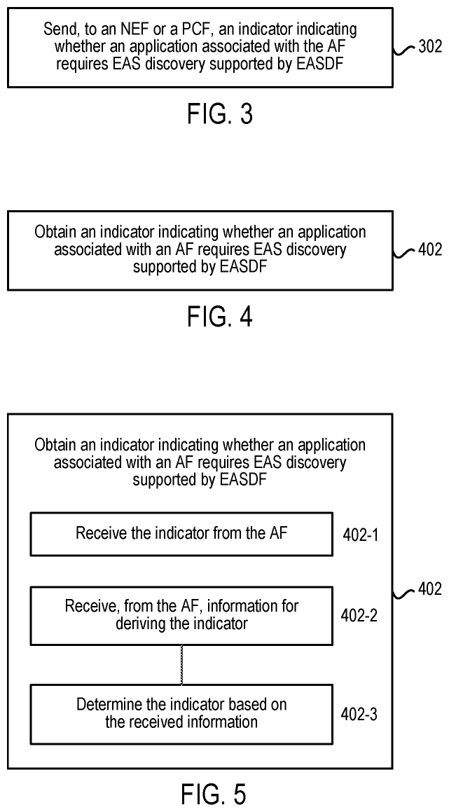

FIG. 3 is a flowchart illustrating a method performed by an AF according to an embodiment of the disclosure. Note that the network function (or network entity) mentioned in this document may be implemented either as a network element on a dedicated hardware, as a software instance running on a dedicated hardware, or as a virtualized function instantiated on an appropriate platform, e.g. on a cloud infrastructure. At block 302, the AF sends, to an NEF or a PCF, an indicator indicating whether an application associated with the AF requires EAS discovery supported by EASDF. For example, the indicator may be configured by an entity associated with the application (e.g. an operator owning or implementing the application). There may be two cases. In the first case, the AF may request to influence traffic routing for a session not identified by a UE address. In this first case, the indicator may be sent to the NEF in a request for influencing traffic routing for the application. As an exemplary example, the request may be an Nnef_TrafficInfluence_Create Request or Nnef_TrafficInfluence_Update Request. In the second case, the AF request for influencing traffic routing may target an individual UE address. In this second case, the indicator may be sent to the PCF in a request for creating or updating a policy for a PDU session associated with the application. As an exemplary example, the request may be an Npcf_PolicyAuthorization_Create Request or Npcf_PolicyAuthorization_Update Request. Note that in the second case, the indicator may also be sent to the NEF in a request for influencing traffic routing for the application. With the method of FIG. 3, since the indicator is provided, it is possible to include this indicator (instead of the EAS deployment information for the application) into PCC rule(s) provisioned to SMF, thereby reducing required bandwidth and implementation complexity for provisioning EAS deployment information.

FIG. 4 is a flowchart illustrating a method performed by an NEF according to an embodiment of the disclosure. At block 402, the NEF obtains an indicator indicating whether an application associated with an AF requires EAS discovery supported by EASDF. For example, as shown in FIG. 5, there may be two options for implementing block 402. As the first option, at block 402-1, the NEF receives the indicator from the AF. As the second option, blocks 402-2 and 402-3 may be performed. At block 402-2, the NEF receives, from the AF, information for deriving the indicator. For example, the information for deriving the indicator may be an identifier identifying the application (e.g. an AF service identifier identifying an AF service which may be a sub-service of the application). The indicator or the information for deriving the indicator may be received from the AF in a request for influencing traffic routing for the application. At block 402-3, the NEF determines the indicator based on the received information. For example, this may be done by using a preconfigured table indicating, for each of a plurality of predetermined applications, whether this application requires EAS discovery supported by EASDF. With the method of FIG. 4, since the indicator is obtained, it is possible to include this indicator (instead of the EAS deployment information for the application) into PCC rule(s) provisioned to SMF, thereby reducing required bandwidth and implementation complexity for provisioning EAS deployment information.

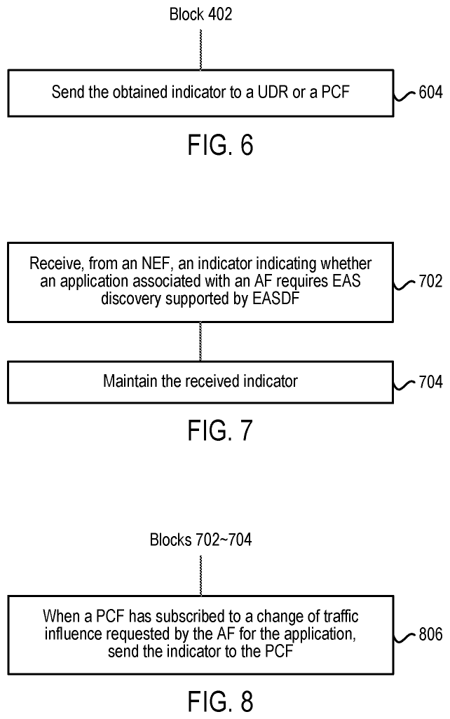

FIG. 6 is a flowchart illustrating a method performed by an NEF according to an embodiment of the disclosure. As shown, the method comprises block 402 described above and block 604. At block 604, the NEF sends the obtained indicator to a UDR or a PCF. For example, in the above first case where the AF may request to influence traffic routing for a session not identified by a UE address, the indicator may be sent to the UDR. In the above second case where the AF request for influencing traffic routing may target an individual UE address, the indicator may be sent to the PCF. For example, the obtained indicator may be sent to the PCF in a request for creating or updating a policy for a PDU session associated with the application. As an exemplary example, the request may be an Npcf_PolicyAuthorization_Create Request or Npcf_PolicyAuthorization_Update Request.

FIG. 7 is a flowchart illustrating a method performed by a UDR according to an embodiment of the disclosure. At block 702, the UDR receives, from an NEF, an indicator indicating whether an application associated with an AF requires EAS discovery supported by EASDF. Block 702 corresponds to the first case of block 604. At block 704, the UDR maintains the received indicator. With the method of FIG. 7, since the indicator is maintained, it is possible to include this indicator (instead of the EAS deployment information for the application) into PCC rule(s) provisioned to SMF, thereby reducing required bandwidth and implementation complexity for provisioning EAS deployment information.

FIG. 8 is a flowchart illustrating a method performed by a UDR according to an embodiment of the disclosure. As shown, the method comprises blocks 702-704 described above and block 806. At block 806, when a PCF has subscribed to a change of traffic influence requested by the AF for the application, the UDR sends the indicator to the PCF. In this way, it is possible for the indicator to be provisioned to SMF via the PCF.

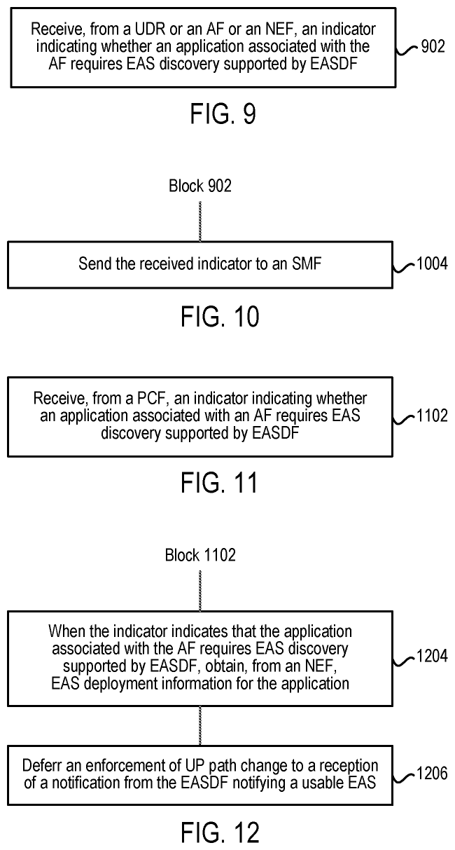

FIG. 9 is a flowchart illustrating a method performed by a PCF according to an embodiment of the disclosure. At block 902, the PCF receives, from a UDR or an AF or an NEF, an indicator indicating whether an application associated with the AF requires EAS discovery supported by EASDF. In the above first case where the AF may request to influence traffic routing for a session not identified by a UE address, the indicator may be received from the UDR. In the above second case where the AF request for influencing traffic routing may target an individual UE address, the indicator may be received from the AF or the NEF. In this case, the indicator may be received in a request for creating or updating a policy for a PDU session associated with the application. As an exemplary example, the request may be an Npcf_PolicyAuthorization_Create Request or Npcf_PolicyAuthorization_Update Request. With the method of FIG. 9, since the indicator is received, it is possible to include this indicator (instead of the EAS deployment information for the application) into PCC rule(s) provisioned to SMF, thereby reducing required bandwidth and implementation complexity for provisioning EAS deployment information.

FIG. 10 is a flowchart illustrating a method performed by a PCF according to an embodiment of the disclosure. As shown, the method comprises block 902 described above and block 1004. At block 1004, the PCF sends the received indicator to an SMF. In both the above first and second cases, the received indicator may be sent to the SMF in a request for notifying updated policy information for a PDU session associated with the application. As an exemplary example, the request may be an Npcf_SMPolicyControl_UpdateNotify Request.

FIG. 11 is a flowchart illustrating a method performed by an SMF according to an embodiment of the disclosure. At block 1102, the SMF receives, from a PCF, an indicator indicating whether an application associated with an AF requires EAS discovery supported by EASDF. Block 1102 corresponds to block 1004. With the method of FIG. 11, since the indicator is received by the SMF, it is possible to reduce required bandwidth and implementation complexity for provisioning EAS deployment information.

FIG. 12 is a flowchart illustrating a method performed by an SMF according to an embodiment of the disclosure. As shown, the method comprises block 1102 described above and blocks 1204-1206. At block 1204, when the indicator indicates that the application associated with the AF requires EAS discovery supported by EASDF, the SMF obtains, from an NEF, EAS deployment information for the application. This may be done by using a new service introduced between the SMF and the NEF, which will be described later. At block 1206, when the indicator indicates that the application associated with the AF requires EAS discovery supported by EASDF, the SMF defers an enforcement of UP path change to a reception of a notification from the EASDF notifying a usable EAS. In this way, the enforcement of UP path change can be performed at an appropriate timing.

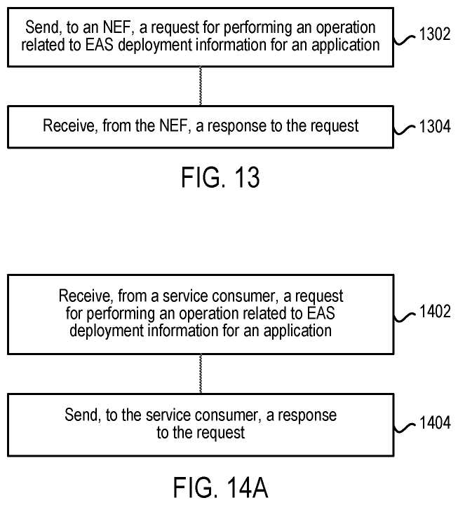

FIG. 13 is a flowchart illustrating a method performed by a service consumer according to an embodiment of the disclosure. At block 1302, the service consumer sends, to an NEF, a request for performing an operation related to EAS deployment information for an application. As a first option, the service consumer may be an AF associated with the application. For this option, the request may be for creating, or updating, or deleting EAS deployment information for the application. As an exemplary example, the request may be an Nnef_EASDeployment_Create/Update/Delete Request. As a second option, the service consumer may be an SMF. For this option, the request may be for subscribing or unsubscribing a notification of a change of EAS deployment information, or for notifying the EAS deployment information. As an exemplary example, the request may be an Nnef_EASDeployment_Subscribe/Unsubscribe/Notify Request. At block 1304, the service consumer receives, from the NEF, a response to the request. With the method of FIG. 13, it is possible to reduce required bandwidth and implementation complexity for provisioning EAS deployment information.

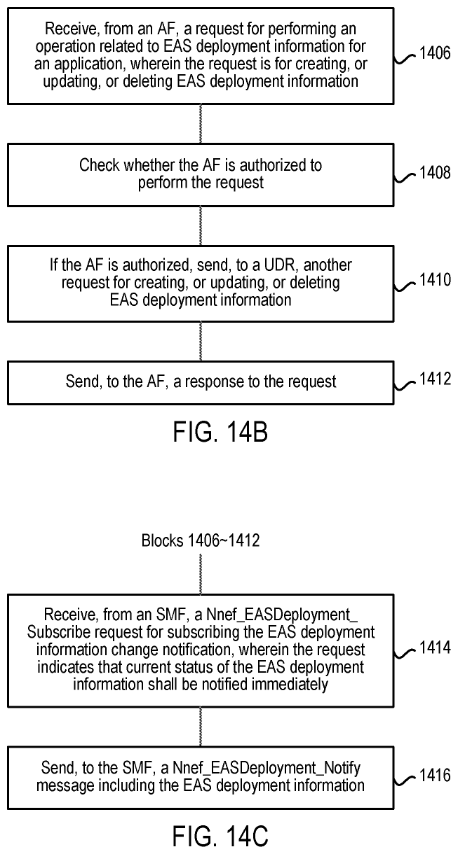

Based on the above description, at least one aspect of the disclosure provides a method performed by an AF. The method comprises sending, to an NEF, a request for performing an operation related to EAS deployment information for an application. The request is for creating, or updating, or deleting EAS deployment information. The method further comprises receiving, from the NEF, a response to the request. With this method, it is possible to reduce required bandwidth and implementation complexity for provisioning EAS deployment information. FIG. 14A is a flowchart illustrating a method performed by an NEF according to an embodiment of the disclosure. At block 1402, the NEF receives, from a service consumer, a request for performing an operation related to EAS deployment information for an application. As a first option, the service consumer may be an AF associated with the application. For this option, the request may be for creating, or updating, or deleting EAS deployment information for the application. As an exemplary example, the request may be an Nnef_EASDeployment_Create/Update/Delete Request. As a second option, the service consumer may be an SMF. For this option, the request may be for subscribing or unsubscribing a notification of a change of EAS deployment information, or for notifying the EAS deployment information. As an exemplary example, the request may be an Nnef_EASDeployment_Subscribe/Unsubscribe/Notify Request. At block 1402, the NEF sends, to the service consumer, a response to the request. With the method of FIG. 14A, it is possible to reduce required bandwidth and implementation complexity for provisioning EAS deployment information.

FIG. 14B is a flowchart illustrating a method performed by an NEF according to an embodiment of the disclosure. At block 1406, the NEF receives, from an AF, a request for performing an operation related to EAS deployment information for an application. The request is for creating, or updating, or deleting EAS deployment information. As an exemplary example, the request may be an Nnef_EASDeployment_Create/Update/Delete Request. At block 1408, the NEF checks whether the AF is authorized to perform the request. At block 1410, if the AF is authorized, the NEF sends, to a UDR, another request for creating, or updating, or deleting EAS deployment information. At block 1412, the NEF sends, to the AF, a response to the request. With the method of FIG. 14B, it is possible to reduce required bandwidth and implementation complexity for provisioning EAS deployment information.

FIG. 14C is a flowchart illustrating a method performed by an NEF according to an embodiment of the disclosure. As shown, the method comprises blocks 1406-1412 described above and blocks 1414-1416. At block 1414, the NEF receives, from an SMF, a Nnef_EASDeployment_Subscribe request for subscribing the EAS deployment information change notification. The request indicates that current status of the EAS deployment information shall be notified immediately. At block 1416, the NEF sends, to the SMF, a Nnef_EASDeployment_Notify message including the EAS deployment information. With the method of FIG. 14C, it is possible to reduce required bandwidth and implementation complexity for provisioning EAS deployment information.

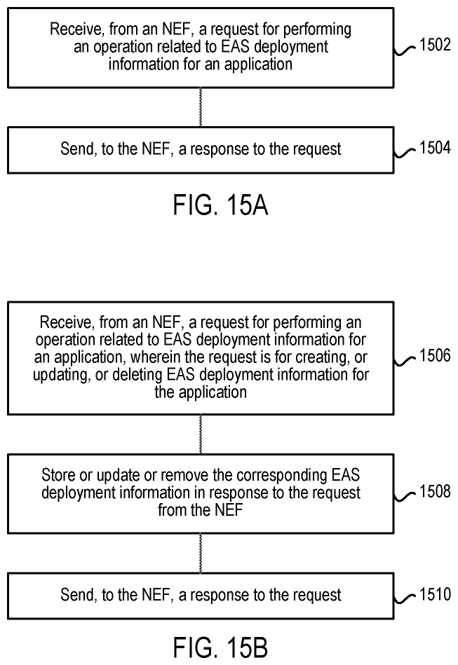

FIG. 15A is a flowchart illustrating a method performed by a UDR according to an embodiment of the disclosure. At block 1502, the UDR receives, from an NEF, a request for performing an operation related to EAS deployment information for an application. For example, the request may be for creating, or updating, or deleting EAS deployment information for the application. As an exemplary example, the request may be an Nudr_DM_Create/Update/Delete Request. At block 1504, the UDR sends, to the NEF, a response to the request. With the method of FIG. 15A, it is possible to reduce required bandwidth and implementation complexity for provisioning EAS deployment information.

FIG. 15B is a flowchart illustrating a method performed by a UDR according to an embodiment of the disclosure. At block 1506, the UDR receives, from an NEF, a request for performing an operation related to EAS deployment information for an application. The request is for creating, or updating, or deleting EAS deployment information for the application. As an exemplary example, the request may be an Nudr_DM_Create/Update/Delete Request. At block 1508, the UDR stores or updates or removes the corresponding EAS deployment information in response to the request from the NEF. At block 1510, the UDR sends, to the NEF, a response to the request. With the method of FIG. 15B, it is possible to reduce required bandwidth and implementation complexity for provisioning EAS deployment information.

Based on the above description, the following changes are suggested to be made to 3GPP TS 23.501 17.1.1, where the added contents are highlighted with underlines and the content within “[[ . . . ]]” refers to the content proposed to be deleted. The main change is to include a new indication in the AF influence traffic data to indicate that the application service refers to an EAS enabled by EASDF.

### 5.6.7.1 General

. . .

TABLE 5.6.7-1
Information element contained in AF request

| | Applicable for PCF or NEF | | |
|---|---|---|---|
| Information Name | (NOTE 1) | Applicable for NEF only | Category |
| Traffic Description | Defines the target traffic to be | The target traffic can be | Mandatory |
| | influenced, represented by the | represented by AF-Service- | |
| | combination of DNN and | Identifier, instead of combination | |
| | optionally S-NSSAI, and | of DNN and optionally S-NSSAI. | |
| | application identifier or traffic | | |
| | filtering information. | | |
| Potential Locations of | Indicates potential locations of | The potential locations of | Conditional |
| Applications | applications, represented by a | applications can be represented | (NOTE 2) |
| | list of DNAI(s). | by AF-Service-Identifier. | |
| Target UE | Indicates the UE(s) that the | GPSI can be applied to identify | Mandatory |
| Identifier(s) | request is targeting, i.e. an | the individual UE, or External | |
| | individual UE, a group of UE | Group Identifier can be applied to | |
| | represented by Internal Group | identify a group of UE. | |
| | Identifier (NOTE 3), or any UE | | |
| | accessing the combination of | | |
| | DNN, S-NSSAI and DNAI(s). | | |
| Spatial Validity | Indicates that the request | The specified location can be | Optional |
| Condition | applies only to the traffic of | represented by a list of | |
| | UE(s) located in the specified | geographic zone identifier(s). | |
| | location, represented by areas | | |
| | of validity. | | |
| AF transaction | The AF transaction identifier | N/A | Mandatory |
| identifier | refers to the AF request. | | |
| N6 Traffic Routing | Routing profile ID and/or N6 | N/A | Optional |
| requirements | traffic routing information | | (NOTE 2) |
| | corresponding to each DNAI | | |
| | and an optional indication of | | |
| | traffic correlation. | | |
| Application | Indicates whether an | N/A | Optional |
| Relocation Possibility | application can be relocated | | |
| | once a location of the | | |
| | application is selected by the | | |
| | 5GC. | | |
| UE IP address | Indicates UE IP address should | N/A | Optional |
| preservation | be preserved. | | |
| indication | | | |
| Temporal Validity | Time interval(s) or duration(s). | N/A | Optional |
| Condition | | | |
| Information on AF | Indicates whether the AF | N/A | Optional |
| subscription to | subscribes to change of UP | | |
| corresponding SMF | path of the PDU Session and | | |
| events | the parameters of this | | |
| | subscription. | | |
| Information for EAS | Indicates the Source EAS | N/A | Optional |
| IP Replacement in | identifier and Target EAS | | |
| 5GC | identifier, (i.e. IP addresses and | | |
| | port numbers of the source and | | |
| | target EAS). | | |
| User Plane Latency | Indicates the user plane latency | N/A | Optional |
| Requirement | requirements | | |
| Information on AF | N/A | Indicates the AF instance | Optional |
| change | | relocation and relocation | |
| | | information. | |
| Indication for EAS | Indicates the EAS relocation of | N/A | Optional |
| Relocation | the application(s) | | |
| Indication of EC | Indicate the information applied | This information can be | Optional |
| application enabled | for EC application traffic with | represented by AF-Service- | |
| by EASDF | EASDF interaction for handling | Identifier. | |
| | DNS message in 5GC. | | |

(NOTE 1):
When the AF request targets existing or future PDU Sessions of multiple UE(s) or of any UE and is sent via the NEF, as described in clause 6.3.7.2, the information is stored in the UDR by the NEF and notified to the PCF by the UDR.
(NOTE 2):
The potential locations of applications and N6 traffic routing requirements may be absent only if the request is for subscription to notifications about UP path management events only.
(NOTE 3):
Internal Group ID can only be used by an AF controlled by the operator and only towards PCF.
. . .
(NOTE 3):
The AF relocation information is applicable for interaction with NEF only and it is not stored in UDR or transferred to PCF, even for the case AF directly interacts with PCF.

14) Indication for EAS relocation. This indicates the application(s) are to be relocated.
13) Indication of EC application enabled by EASDF. This indicates the application traffic is applicable for EC service activation with 5GC taking care of DNS message handling by EASDF intervention.

When the PCC rules are activated, the SMF may, based on local policies, take the information in the PCC rules and, optionally, the Service Experience analytics and/or DN Performance analytics per UP path (including UPF and/or DNAI and/or AS instance) as defined in clause 6.4.3 and clause 6.14.3, respectively, of TS 23.288 into account to:
(re) select UP paths (including DNAI(s)) for PDU Sessions. The SMF is responsible for handling the mapping between the UE location (TAI/Cell-Id) and DNAI(s) associated with UPF and applications and the selection of the UPF(s) that serve a PDU Session. This is described in clause 6.3.3. If the PDU Session is of IP type and if Indication of UE IP address preservation is included in the PCC rules, the SMF should preserve the UE IP address, by not reselecting the related PSA UPF once the PSA UPF is selected, for the traffic identified in the PCC rule. If the user plane latency requirement is included in the PCC rules, the SMF chooses the PSA UPF that satisfies the user plane latency requirement. If the PCC rules are related to a 5G VN group served by the SMF and if the Information about the N6 traffic routing requirements includes an indication of traffic correlation, the SMF should select a common DNAI for the PDU Sessions of the 5G VN group.
configure traffic steering at UPF, including activating mechanisms for traffic multi-homing or enforcement of an UL Classifier (UL CL). Such mechanisms are defined in clause 5.6.4. This may include that the SMF is providing the UPF with packet handling instructions (i.e. PDRs and FARs) for steering traffic to the local access to the DN. The packet handling instructions are generated by the SMF using the traffic steering policy ID and/or the N6 traffic routing information in the PCC rules corresponding to the applied DNAI. In the case of UP path reselection, the SMF may configure the source UPF to forward traffic to the UL CL/BP so that the traffic is steered towards the target UPF.
if Information on AF subscription to corresponding SMF events has been provided in the PCC rule, inform the AF of the (re) selection of the UP path (UP path change). If the information includes an indication of “AF acknowledgment to be expected”, the SMF may decide to wait for a response from the AF before it activates the new UP path, as described in clause 5.6.7.2.
if indication of EC application activation has been provided in the PCC rule, the SMF shall defer the enforcement of UP path change to the reception of the EASDF notification as described in TS 23.548 [130].
. . .

### 6.2.5.0 NEF Functionality

Support of UAS NF functionality:
   Details are defined in TS 23.256 [136].
Support of EAS deployment functionality:
   Details are defined in TS 23.548 [130].
      . . .

### 7.2.8 NEF Services

The following NF services are specified for NEF:

TABLE 7.2.8-1
NF Services provided by NEF

| | | Reference in |
|---|---|---|
| | | TS 23.502 [3] |
| Service Name | Description | or other TS |
| Nnef_EventExposure | Provides support for event exposure. | 5.2.6.2 |
| Nnef_AKMA | AKMA Application Key derivation service | TS 33.535 [124] |
| Nnef_EASDeployment | EAS deployment service. | TS 23.548 [130] |

The following changes are suggested to be made to 3GPP TS 23.503 17.1.0, where the added contents are highlighted with underlines and the content within “[[ . . . ]]” refers to the content proposed to be deleted. Specifically, the NEF stores the above information in the UDR or forwards it to the PCF using the N5 interface. The PCF uses this information to build the PCC rule, which will further on include this indication. The indication of EC application enabled by EASDF indicates whether activation of the EC application traffic with EASDF interaction for handling DNS message in 5GC applies.

### 6.3.1 General

. . .

TABLE 6.3.1
The PCC rule information in 5GC

| | | | PCF permitted | Differences |
|---|---|---|---|---|
| | | | to modify for | compared with |
| Information | | | a dynamic PCC | table 6.3. in |
| name | Description | Category | rule in the SMF | TS 23.203 [4] |
| Rule identifier | Uniquely identifies the PCC rule, | Mandatory | No | None |
| | within a PDU Session. | | | |
| | It is used between PCF and SMF | | | |
| | for referencing PCC rules. | | | |
| . . . | . . . | . . . | . . . | . . . |
| AF influenced | This part describes information | | | |
| Traffic Steering | required for AF influenced Traffic | | | |
| Enforcement | Steering. | | | |
| Control | | | | |
| (NOTE 18) | | | | |
| Data Network | Identifier(s) of the target Data | | Yes | Added |
| Access Identifier | Network Access (DNAI). It is | | | |
| | defined in clause 5.6.7 of | | | |
| | TS 23.501 [2]. | | | |
| Per DNAI: | Reference to a pre-configured | | Yes | Added |
| Traffic steering | traffic steering policy at the SMF | | | |
| policy identifier | (NOTE 19). | | | |
| Per DNAI: N6 | Describes the information | | Yes | Added |
| traffic routing | necessary for traffic steering to | | | |
| information | the DNAI. It is described in | | | |
| | clause 5.6.7 of TS 23.501 [2] | | | |
| | (NOTE 19). | | | |
| Information on | Indicates whether notifications in | | Yes | Added |
| AF subscription | the case of change of UP path | | | |
| to UP change | are requested and optionally | | | |
| events | indicates whether | | | |
| | acknowledgment to the | | | |
| | notifications shall be expected | | | |
| | (as defined in clause 5.6.7 of | | | |
| | TS 23.501 [2]) | | | |
| Indication of UE | Indicates UE IP address should | | Yes | Added |
| IP address | be preserved. It is defined in | | | |
| preservation | clause 5.6.7 of TS 23.501 [2]. | | | |
| Indication of | Indicates that the target PDU | | Yes | Added |
| traffic | Sessions should be correlated | | | |
| correlation | via a common DNAI in the user | | | |
| | plane. It is described in | | | |
| | clause 5.6.7 of TS 23.501 [2]. | | | |
| Information on | Indicates the user plane latency | | Yes | Added |
| User Plane | requirements. (see | | | |
| Latency | TS 23.548 [33]). | | | |
| requirements | | | | |
| Information for | Indicates the Source EAS | | Yes | Added |
| EAS IP | identifier and Target EAS | | | |
| Replacement in | identifier, (i.e. IP addresses and | | | |
| 5GC | port numbers of the source and | | | |
| | target EAS). (see clause 5.6.7 of | | | |
| | TS 23.501 [2]) | | | |
| Indication of EC | Indicates whether the EC | | Yes | Added |
| application | application activation applies for | | | |
| enabled by | the target traffic with EASDF | | | |
| EASDF | interaction for handling DNS | | | |
| | message in 5GC. | | | |
| NBIFOM | This part describes PCC rule | | | |
| related control | information related with | | | |
| Information | NBIFOM. | | | |
| Allowed Access | The access to be used for traffic | | | Removed |
| Type | identified by the PCC rule. | | | |
| . . . | . . . | . . . | . . . | . . . |

. . .
. . .

The AF influenced Traffic Steering Enforcement Control contains:
a set of DNAI(s) (i.e. a reference to the DNAI(s) the SMF needs to consider for UPF selection/reselection), an optional Indication of traffic correlation and, per DNAI, a corresponding Traffic steering policy identifier (i.e. a reference to a pre-configured traffic steering policy at the SMF), and/or a corresponding N6 traffic routing information (when the N6 traffic routing information is provided explicitly as part of the AF influence request, as described in clause 5.6.7 of TS 23.501 [2]), or;
an AF subscription to UP change events parameter which contains subscription information defined in clause 5.2.8.3 of TS 23.502 [3] for the change of UP path Event Id i.e. an Indication of early and/or late notification and information on where to provide the corresponding notifications (Notification Target Address+Notification Correlation ID as specified in clause 4.15.1 of TS 23.502 [3]) and optionally an indication of “AF acknowledgment to be expected” to the corresponding notifications as described in clause 5.6.7 of TS 23.501 [2].
a user plane latency requirements parameter which contains AF requested information on the requirements for user plane latency defined in TS 23.548 [33].
an indication of EC application enabled by EASDF which indicates whether activation of the EC application traffic with EASDF interaction for handling DNS message in 5GC applies.

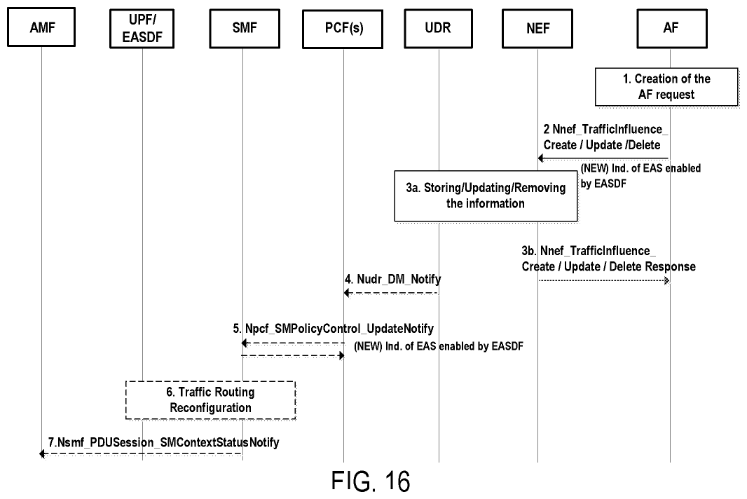

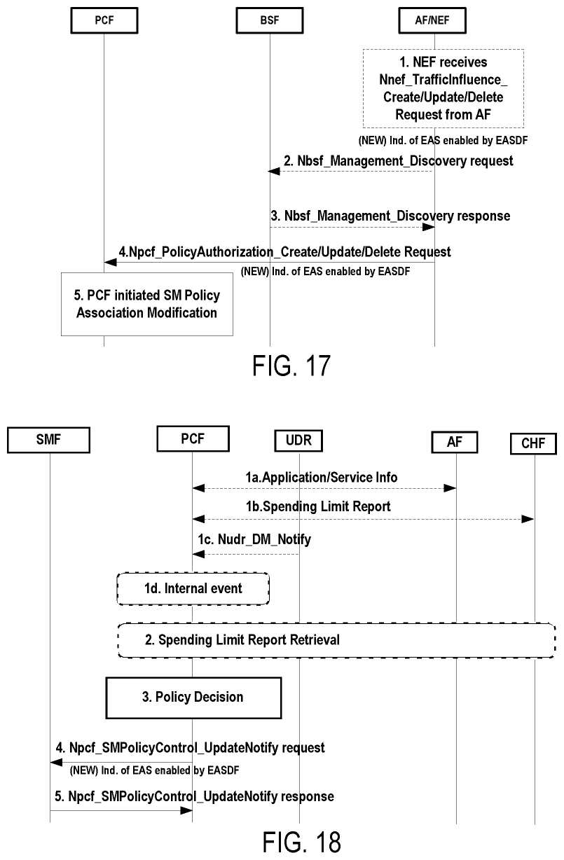

The following changes are suggested to be made to 3GPP TS 23.502 17.1.0, where the added contents are highlighted with underlines and the content within “[[ . . . ]]” refers to the content proposed to be deleted. Specifically, EAS deployment information should be provided by NEF to the SMF via UDR not via PCF. It is proposed to remove the EAS deployment information from PCF policy authorization service and NEF traffic influence service. Note that FIG. 16 illustrates the process corresponding to section 4.3.6.2. FIG. 17 illustrates the process corresponding to section 4.3.6.4. FIG. 18 illustrates the process corresponding to section 4.16.5.2.

### 4.3.6.1 General

. . .

If the AF interacts with PCF via the NEF, the NEF performs the following mappings where needed:
Map the AF-Service-Identifier into DNN and S-NSSAI combination, determined by local configuration.
Map the AF-Service-Identifier into a list of DNAI(s) and Routing Profile ID(s) determined by local configuration.
The NEF can only provide this mapping when the DNAI(s) being used by the applications are statically defined. When the DNAI(s) where applications are instantiated may vary dynamically, the AF should provide the target DNAI(s) in its request together with either Routing Profile ID(s) or with N6 traffic routing information.
Map the GPSI in Target UE Identifier into SUPI, according to information received from UDM.
Map the External Group Identifier in Target UE Identifier into Internal Group Identifier, according to information received from UDM.
Map the geographic zone identifier(s) in Spatial Validity Condition into areas of validity, determined by local configuration.
Map the AF-Service-Identifier into indication of EC application enabled by EASDE, determined by local configuration.

4.3.6.2 Processing AF requests to influence traffic routing for Sessions not identified by an UE address
1. To create a new request, the AF invokes a Nnef_TrafficInfluence_Create service operation. The content of this service operation (AF request) is defined in clause 5.2.6.7. The request contains also an AF Transaction Id. If it subscribes to events related with PDU Sessions the AF indicates also where it desires to receive the corresponding notifications (AF notification reporting information).
   To update or remove an existing request, the AF invokes a Nnef_TrafficInfluence_Update or Nnef_TrafficInfluence_Delete service operation providing the corresponding AF Transaction Id.
   The Nnef_TrafficInfluence_Create (initiated by target AF) or
   Nnef_TrafficInfluence_Update (initiated by source AF or target AF) service operation may be used for the case of AF instance change. If Nnef_TrafficInfluence_Update service operation is invoked, the NEF is required to update the subscription resource. The Nnef_TrafficInfluence_Update service operation may include an updated notification target address. The updated subscription resource is used by the target AF.
NOTE 3: If the source AF transfers the application context to the target AF, then target AF may create new subscription via Nnef_TrafficInfluence_Create operation or update existing subscription via Nnef_TrafficInfluence_Update. However, whether and how the application context transfer is done is out of this specification.
2. The AF sends its request to the NEF. If the request is sent directly from the AF to the PCF, the AF reaches the PCF selected for the existing PDU Session by configuration or by invoking Nbsf_management_Discovery service.
   The NEF ensures the necessary authorization control, including throttling of AF requests and, as described in clause 4.3.6.1, mapping from the information provided by the AF into information needed by the 5GC.
(NEW) The NEF determines based on the AF service identifier whether the service request is for an EAS enabled by EASDF. If it is so, it includes the indication in the N5 request to the PCF or in the UDR request to create store the received information.
3. (in the case of Nnef_TrafficInfluence_Create or Update): The NEF stores the AF request information in the UDR (Data Set=Application Data; Data Subset=AF traffic influence request information, Data Key=AF Transaction Internal ID, S-NSSAI and DNN and/or Internal Group Identifier or SUPI).
NOTE 4: Both the AF Transaction Internal ID and, S-NSSAI and DNN and/or Internal Group Identifier or SUPI are regarded as Data Key when the AF request information are stored into the UDR, see Table 5.2.12.2.1-1.
(NEW) The NEF stores the derived indication about EAS enabled by EASDF into the UDR. (in the case of Nnef_TrafficInfluence_delete): The NEF deletes the AF requirements in the UDR (Data Set=Application Data; Data Subset=AF traffic influence request information, Data Key=AF Transaction Internal ID).
   The NEF responds to the AF.
4. The PCF(s) that have subscribed to modifications of AF requests (Data Set=Application Data; Data Subset=AF traffic influence request information, Data Key=S-NSSAI and DNN and/or Internal Group Identifier or SUPI) receive(s) a Nudr_DM_Notify notification of data change from the UDR.
(NEW) The UDR notification about data change include the indication about EAS enabled by EASDF
5. The PCF determines if existing PDU Sessions are potentially impacted by the AF request. For each of these PDU Sessions, the PCF updates the SMF with corresponding new policy information about the PDU Session by invoking Npcf_SMPolicyControl_UpdateNotify service operation as described in steps 5 and 6 in clause 4.16.5.
   If the AF request includes a notification reporting request for UP path change, the PCF includes in the PCC rule(s) the information required for reporting the event, including the Notification Target Address pointing to the NEF or AF and the Notification Correlation ID containing the AF Transaction Internal ID.
(NEW) The PCF provides, together with the existing DNAI information, whether the application is an EAS enabled by EASDF.
   The PCF may, optionally, use service experience analytics per UP path, as defined in clause 6.4.3, TS 23.288 [50], to provide an updated list of DNAI(s) to the SMF.
6. When the updated policy information about the PDU Session is received from the PCF, the SMF may take appropriate actions to reconfigure the User plane of the PDU Session. The SMF may consider service experience analytics and/or DN Performance analytics per UP path (i.e. including UPF and/or DNAI and/or AS instance) as defined in clauses 6.4.3 and 6.14.3, respectively, of TS 23.288 before taking such actions. Examples of actions are:
   Determining a target DNAI and adding, replacing or removing a UPF in the data path to e.g. act as an UL CL or a Branching Point e.g. as described in clause 4.3.5.
   Allocate a new Prefix to the UE (when IPv6 multi-Homing applies).
   Updating the UPF in the target DNAI with new traffic steering rules.
   Subscribe to notifications from the AMF for an Area of Interest via Namf_EventExposure_Subscribe service operation.
   Determining whether to relocate PSA UPF considering the user plane latency requirements provided by the AF (see clause 6.3.6 of TS 23.548 [74]).

When the updated policy information about the (NEW) EC application enabled by EASDF [[PDU Session related to EAS deployment]] information is received from the PCF, the SMF may take appropriate actions to assist the EAS discovery and re-discovery for PDU Session with Session Breakout connectivity model such as:
Retrieve the EAS deployment information as defined in clause 6.2.3.4.1 of TS 23.548 [74].
Providing DNS message handling rule to forward DNS messages of the UE and/or report when detecting DNS messages as defined in clause 6.2.3.2.2 of TS 23.548 [74].
7. The SMF may decide whether it is required to send the target DNAI to the AMF for triggering SMF/I-SMF (re) selection and then inform the target DNAI information for the current PDU session or for the next PDU session to AMF via Nsmf_PDUSession_SMContextStatusNotify service operation.

### 5.2.5.3.2 Npcf_PolicyAuthorization_Create Service Operation

. . .

Inputs, Optional: UE identity if available, DNN if available, S-NSSAI if available, Media type, Media format, bandwidth requirements, sponsored data connectivity if applicable, flow description, Application Identifier, AF Communication Service Identifier, AF Record Identifier, Flow status, Priority indicator, emergency indicator, Application service provider, resource allocation outcome, AF Application Event Identifier, a list of DNAI(s) and corresponding routing profile ID(s) or N6 traffic routing information, AF Transaction Id, Early and/or late notifications about UP path management events, temporal validity condition, spatial validity condition, Information for EAS IP Replacement in 5GC and EC application enabled by EASDF indication [[and EAS deployment information]] as described in clause 5.6.7 in 23.501 [2], Background Data Transfer Reference ID, priority sharing indicator as described in clause 6.1.3.15 in TS 23.503 [20], pre-emption control information as described in clause 6.1.3.15 in TS 23.503 [20], Port Management Information Container and related port number, TSN AF parameters provided by the TSN AF to the PCF as described in clause 6.1.3.23 of TS 23.503 [20], Alternative QOS Related parameter set(s), QoS parameter(s) to be measured, Reporting frequency, Target of reporting as described in clause 6.1.3.21 of TS 23.503 [20], individual QoS parameters as described in clause 6.1.3.22 of TS 23.503 [20], Alternative Service Requirements (containing one or more QoS reference parameters in a prioritized order), MPS for Data Transport Service indicator as described in clause 6.1.3.11 of TS 23.503 [20].

. . .

### 5.2.5.3.3 Npcf_PolicyAuthorization_Update Service Operation

. . .

Inputs, Optional: Media type, Media format, bandwidth requirements, sponsored data connectivity if applicable, flow description, Application Identifier, AF Communication Service Identifier, AF Record Identifier, Flow status, Priority indicator, Application service provider, resource allocation outcome, AF Application Event Identifier, a list of DNAI(s) and corresponding routing profile ID(s) or N6 traffic routing information, AF Transaction Id, Early and/or late notifications about UP path management events, temporal validity condition, spatial validity condition, Information for EAS IP Replacement in 5GC and EC application enabled by EASDF indication [[and EAS deployment information]] as described in clause 5.6.7 of TS 23.501 [2], Background Data Transfer Reference ID, priority sharing indicator as described in clause 6.1.3.15 of TS 23.503 [20], pre-emption control information as described in clause 6.1.3.15 of TS 23.503 [20], Port Management Information Container and related port number, TSN AF parameters provided by the TSN AF to the PCF as described in clause 6.1.3.23 of TS 23.503 [20], individual QOS parameters as described in clause 6.1.3.22 of TS 23.503 [20], Alternative QoS Related parameter set(s), QOS parameter(s) to be measured, Reporting frequency, Target of reporting as described in clause 6.1.3.21 of TS 23.503 [20], MPS for Data Transport Service indicator as described in clause 6.1.3.11 of TS 23.503 [20].

. . .

### 5.2.6.7.2 Nnef_TrafficInfluence_Create Operation

. . .

Inputs, Optional: The address (IP or Ethernet) of the UE if available, GPSI if available, DNN if available, S-NSSAI if available, External Group Identifier if available, External Application Identifier or traffic filtering information, AF-Service-Identifier, a list of DNAI(s) and corresponding routing profile ID(s) or N6 traffic routing information, Indication of traffic correlation, Indication of application relocation possibility, Indication of UE IP address preservation. Early and/or late notifications about UP path management events, Notification Target Address, Temporal validity condition, Spatial validity condition, User Plane Latency Requirements, Information for EAS IP Replacement in 5GC and EC application enabled by EASDF indication [[and EAS deployment information]] as described in clause 5.6.7 of TS 23.501 [2].

. . .

### 5.2.6.7.3 Nnef_TrafficInfluence_Update Operation

Inputs, Optional: Same optional information as in Nnef_TrafficInfluence_Create Input, AF ID [[, Notification Target Address]].

### 4.3.6.4 Transferring an AF Request Targeting an Individual UE Address to the Relevant PCF

. . .

FIG. 4.3.6.4-1: Handling an AF request targeting an individual UE address to the relevant PCF Depending on the AF deployment (see clause 6.2.10 of TS 23.501 [2]), the AF may send the AF request to PCF directly, in which case step 1 is skipped, or via the NEF.
1. [Conditional] If the AF sends the AF request via NEF, the AF sends Nnef_TrafficInfluenceCreate/Update/Delete Request targeting an individual UE address to the NEF. This request corresponds to an AF request to influence traffic routing that targets an individual UE address.
   When NEF receives an AF request from AF, the NEF ensures the necessary authorization control and, as described in clause 4.3.6.1, mapping from the information provided by the AF into information needed by the 5GC. The NEF responds to the AF.
(NEW) The NEF may receive an indication about EAS enabled by EASDF from the AF.
2. [Conditional] AF/NEF consumes Nbsf_Management_Discovery service operation (providing at least the UE address) to find out the address of the relevant PCF if the PCF address is not available on the NEF based on local configuration, otherwise step 1 is skipped.
NOTE: The AF/NEF finds the BSF based on local configuration or using the NRF.
3. BSF provides the PCF address in the Nbsf_Management_Discovery response to AF/NEF.
4. If step 1 was performed, NEF invokes the Npcf_PolicyAuthorization service to the PCF to transfer the AF request. If an AF sends the AF request directly to the PCF, AF invokes Npcf_PolicyAuthorization service and the PCF responds to the AF.
(NEW) The AF/NEF may include the indication about EAS enabled by EASDF.
5. The PCF authorizes the AF request. If the PCF determines that the requirements can't be authorized, it rejects the AF request. Once the PCF authorizes the AF request, the PCF updates the SMF with corresponding new PCC rule(s) with PCF initiated SM Policy Association Modification procedure as described in clause 4.16.5.2.
   The PCF may, optionally, use service experience analytics per UP path, as defined in clause 6.4.3. TS 23.288 [50], to provide a an updated list of DNAI(s) to the SMF. When a PCC rule is received from the PCF, the SMF may take appropriate actions, when applicable, to reconfigure the User plane of the PDU Session. The SMF may consider service experience analytics and/or DN Performance analytics per UP path (i.e. including UPF and/or DNAI and/or AS instance) as defined in clauses 6.4.3 and 6.14.3, respectively, of TS 23.288 before taking such actions. Examples of actions are:
      Determining a target DNAI and adding, replacing or removing UPF(s) in the data path, e.g. to act as UL CL, Branching Point, and/or PDU Session Anchor e.g. as described in clause 4.3.5.
      Allocate a new Prefix to the UE (when IPv6 multi-Homing applies).
      Updating the UPF regarding the target DNAI with new traffic steering rules.
      Subscribe to notifications from the AMF for an Area of Interest via Namf_EventExposure_Subscribe service operation.
      Determining whether to relocate PSA UPF considering the user plane latency requirements provided by the AF (see clause 6.3.6 of TS 23.548 [74]).

### 4.16.5.2 PCF Initiated SM Policy Association Modification

The PCF may initiate SM Policy Association Modification procedure based on internal PCF event or triggered by other peers of the PCF (AF, NWDAF, CHF, UDR).

. . .

### FIG. 4.16.5.2-1: PCF Initiated SM Policy Association Modification

This procedure may be triggered by a local decision of the PCF or based on triggers from other peers of the PCF (AF, NWDAF, CHF, UDR):

An SM Policy Association is established, with the PCF as described in clause 4.16.4 before this procedure is triggered.

For local breakout roaming, the interaction with HPLMN (e.g. step 1b and step 2) is not used. In local breakout roaming, the V-PCF interacts with the UDR of the VPLMN.
1a. Alternatively, optionally, the AF or NEF provides/revokes service information to the PCF e.g. due to AF session signalling, by invoking Npcf_PolicyAuthorization_Create Request or Npcf_PolicyAuthorization_Update Request service operation. The PCF responds to the AF or NEF.
1b. Alternatively, optionally, the CHF provides a Spending Limit Report to the PCF as described in clause 4.16.8. and responds to the CHF.
1c. Alternatively, optionally, the UDR notifies the PCF about a policy subscription change by invoking Nudr_DM_Notify (Notification correlation Id, Policy Data, SUPI, updated data, “PDU Session Policy Control Data”|“Remaining allowed Usage data”); The PCF responds to the UDR.
1d. Alternatively, optionally, some internal event (e.g. timer, or local decision based on analytics information requested and received from NWDAF) occurs at the PCF. The analytics (i.e. Analytics ID) which can be requested from NWDAF are described in clause 6.1.1.3 of TS 23.503 [20].
2. If the PCF determines a change to policy counter status reporting is required, it may alter the subscribed list of policy counters using the Initial, Intermediate or Final Spending Limit Report Retrieval procedures as defined in clause 4.16.8.
NOTE: The PCF ensures that information received in step 1 and 2 can be used by later policy decisions.
3. The PCF makes a policy decision. The PCF may determine that updated or new policy information need to be sent to the SMF. In the non-roaming case, the PCF may also decide to subscribe to a new Analytics ID from NWDAF as described in clause 6.1.1.3 of TS 23.503 [20].
   If the AF provided a Background Data Transfer Reference ID in step 1a, the PCF may retrieve it from the UDR by invoking the Nudr_DM_Query (BDT Reference Id, Policy Data, Background Data Transfer) service.
4. If the PCF has determined that SMF needs updated policy information in step 3 or if the PCF has received a Port Management Information Container for the PDU Session and related port number from the AF or NEF in Step 1a, the PCF issues a Npcf_SMPolicyControl_UpdateNotify request with possibly updated policy information about the PDU Session.
(NEW) The PCF provides, together with the existing DNAI information, whether the application is an EAS enabled by EASDF.
5. The SMF acknowledges the PCF request with a Npcf_SMPolicyControl_UpdateNotify response.
   If the Npcf_SMPolicyControl_UpdateNotify request is received from new PCF instance in the PCF Set, the SMF store the SM policy association towards the new PCF instance.

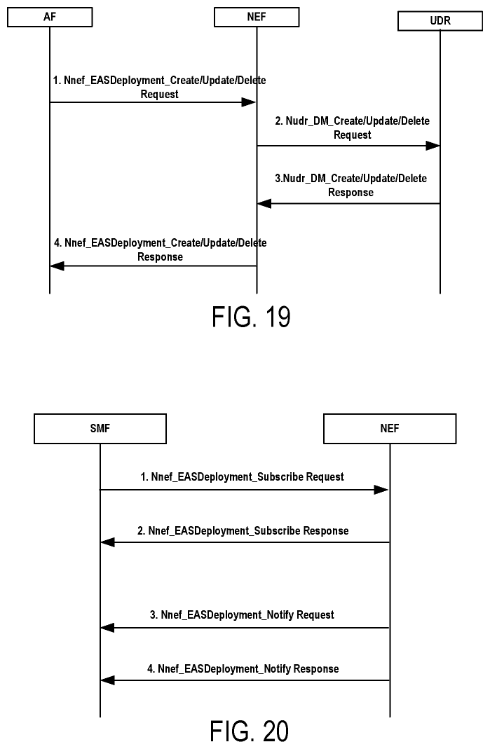

The following changes are suggested to be made to 3GPP TS 23.548 1.0.0, where the added contents are highlighted with underlines and the content within “[[ . . . ]]” refers to the content proposed to be deleted. Specifically, a new service is defined in NEF, Nnef_EASDeployment, to enable an AF can provide EAS deployment information in the different Edges of the network. FIG. 19 illustrates the process corresponding to section 6.2.3.4.x. FIG. 20 illustrates the process corresponding to section 6.2.3.4.1.

### Provisioning of EAS Deployment Information

The node level provisioning of EAS deployment info from AF is still not specified. Such information can be provisioned via a new NEF service and stored in UDR.’

For SMF to receive EAS deployment info from UDR, this can be done with push mode only aiming for simplification. For node level provisioning, once subscription is done (via NEF), any data change in UDR will be notified to SMF. “Immediate Report Indication” can be used to retrieve the initial status of the EAS deployment info. The subs-notif procedures enable the SMF to receive EAS deployment information for an Application Identifier from the NEF when a PCC rule with this Application Identifier (subjected to EC activation with DNS control) is provided/activated and EAS deployment information are not available at the SMF.

In addition, “allowed delay” gives the flexibility to the AF to provision EAS deployment info in advance (similar as PFD provisioning).

6.2.3.2.2 EAS Discovery Procedure with EASDF

For the case that the UE DNS Query is to be handled by EASDF, the following applies.
The AF may provide EAS deployment information to UDR via NEF, including the list of FQDNs supported by applications [[for each DNAI]], the IP address range(s) corresponding to each DNAI and the DNS server identifier (consisting of IP address and port) for each DNAI, as defined in clause [[5.6.7 of TS 23.501 [2]. The AF may update the information as described in clause 4.3.6.2 of TS 23.502 [3]]] 6.2.3.4. SMF may retrieve EAS deployment information from NEF as described in 6.2.3.4 or has local preconfigured information.
During the PDU Session establishment procedure, the SMF gets [[the EAS deployment information via]] the PDU Session [[related]] policy information from PCF [[or the SMF is preconfigure with the EAS deployment information the]] and the SMF selects an EASDF and provides its address to the UE as the DNS Server to be used for the PDU Session.
   . . .
NOTE 6: To avoid SMF overloading caused by massive reporting, the overload control mechanisms defined in clause 6.4 of TS 29.500 [9] can be used.

The information to build the EDNS Client Subnet option or the Local DNS server address provided by the SMF to the EASDF are part of the DNS message handling rules to handle DNS queries from the UE. This information is related to DNAI(s) for that FQDN(s) for the UE location. The SMF may provide DNS message handling rules to handle DNS queries from the UE to the EASDF when the SMF establishes the association with the EASDF for the UE and may update the rules at any time when the association exists. For the selection of the candidate DNAI for an FQDN for the UE, the SMF may consider the UE location, network topology EAS deployment information and [[received as part of PDU Session]] related policy information for the PDU Session [[while it is]] provided/modified/deleted by PCF as defined in TS 23.503 [4] clause 6.4 [[or be preconfigured into the SMF]]. The EAS deployment information is provisioned by the AF via the procedure described in clause 6.2.3.4.x or preconfigured into the SMF. [[of AF influence on traffic routing as defined in in clause 5.6.7.1 of TS 23.501 [2] and in clause 4.3.6.2 of TS 23.502 [3].]] After the UE mobility, if the provided Information for EDNS Client Subnet option or the Local DNS server address needs be updated, the SMF may send an update to DNS message forwarding rules to the EASDF.
NOTE 7: To protect the SMF (e.g. to block DOS from the EASDF), the EASDF IP address for DNS Query Request is only accessible from the UE IP address via UPF.
   [[Editor's note: The procedure for AF provisioning of the EAS Deployment information is FFS.]]
   . . .
16. The SMF may perform UL CL/BP and Local PSA selection and insert UL CL/BP and Local PSA.

Based on received EAS information received from the EASDF, other UPF selection criteria, as specified in clause 6.3.3 in TS 23.501 [2], and Service Experience or DN performance

analytics for an Edge Application as described in TS 23.288 [10], the SMF may determine the DNAI and determine the associated N6 traffic routing information for the DNAI. The SMF may perform UL CL/BP and Local PSA selection and insertion as described in TS 23.502 [3]. In case of UL CL, the traffic detection rules and traffic routing rules are determined by the SMF based on IP address range(s) per DNAI included in the EAS deployment information. [[the PCC rules as defined in clause 5.6.7 in TS 23.501 [2]. Or the SMF determines the traffic detection rules and traffic routing rules based on the IP address range(s) per DNAI included in the preconfigured EAS deployment information.]]

. . .

### 6.2.3.3 EAS Re-Discovery Procedure at Edge Relocation

. . .
2. This step may be performed as part of step 1a/1b. The SMF performs the network requested PDU Session Modification procedure from the step 3b-11b as defined in clause 4.3.3.2 TS 23.502 [3].
   If the UE has indicated that it supports to refresh EAS information stored locally corresponding to the impact field per the EAS rediscovery indication from network, the SMF may send the impact field with the EAS rediscovery indication. SMF determines the impacted EAS(s) which need be rediscovered as the following:
      If an L-PSA is inserted/relocated/removed, the SMF determines the impact field, which is associated with the L-DN to be inserted, relocated or removed and identified by FQDN(s) or IP address range(s) of the old EAS, based on the association between FQDN(s)/IP address range(s) and DNAI [[received from]] provided by AF [[via AF influenced traffic steering enforcement control information in the PCC rules]] or on SMF local configuration on the L-DN.
      For AF triggered EAS rediscovery, the AF may indicate the EAS rediscovery for the impacted applications, which are identified by Application Identifier(s) [[FQDN(s)]], to the SMF via the AF influence on traffic routing procedure.
         . . .

### 6.2.3.4 Node Level EAS Deployment Information Management

The node level EAS deployment information management procedures are described in this clause, the procedures are independent of any PDU Session, including:
the procedure for EAS deployment information management in the SMF[[, and]];
the procedure for EAS deployment information management in the EASDF[[.]]; and
the procedure for EAS deployment information management via the NEF.

### 6.2.3.4.1 EAS Deployment Information Management in the SMF

The SMF may receive the EAS deployment information from the NEF via [[UDR via NEF via pull mode or]] push mode as shown in the figure below.

The NEF retrieves the EAS deployment information from UDR unless already available in NEF.
[[Editor's note: It is FFS whether the interaction between SMF and UDR needs to go via NEF.
Editor's note: If both modes push and pull are needed is FFS.]]
. . .

### [[For Pull Mode:

1. SMF may invokes the Nnef_EASDeployment_Fetch (DNN and/or DNAI(s)) and/or application(s) to the NEF. The SMF may fetch all the EAS deployment information for the DNN or for DNAI(s).
2. The NEF invokes Nudr_DM_Query (DNN and/or DNAI(s) and/or application(s)) to retrieve the EAS deployment information from UDR.
3. The UDR provides a Nudr_DM_Query response with EAS deployment information for the DNN and/or DNAI(s) and/or application(s) to the NEF.
4. The NEF replies to the SMF with Nnef_EASDeployment_Fetch Response with EAS deployment information.

### For Push Mode:]]

1-2. As pre-requisite condition to receiving push notifications, the SMF subscribes to EAS deployment information change notification from the NEF by sending Nnef EASDeployment Subscribe message. The SMF indicates that the current status of EAS deployment information shall be notified immediately (if available).
3-4. The NEF invokes Nnef_EASDeployment_Notify (DNN and/or DNAI(s) and/or application(s). EAS deployment information) to the SMF(s) to which the EAS deployment information shall be provided. If there is EAS deployment information available and immediate report is required, the NEF notifies the SMF(s) with such information. The NEF may decide to delay the distribution of EAS deployment information to the SMF(s) for some time to optimize the signalling load. If the NEF received an Allowed Delay for a EAS deployment information, the NEF shall distribute this EAS deployment information within the indicated time interval.

The procedures enable the SMF to receive EAS deployment information from the NEF for an Application Identifier when a PCC rule with this Application Identifier (subjected to EC activation with DNS control) is provided/activated and EAS deployment information are not available at the SMF.

[[for DNN and/or DNAI(s) and/or application(s) when a PDU Session for the DNN and/or DNAI(s) is established and EAS deployment information provided by the NEF are not available at the SMF. In addition, the procedures also enable the SMF to retrieve EAS deployment information from the NEF when the caching timer for the EAS deployment information elapses and there is/are PDU session(s) for this DNN and/or DNAI(s) and/or application(s).]] Either the complete list or a subset of EAS deployment information for one or more application(s) [[DNN and/or DNAI(s), or a subset of EAS deployment information for individual DNN and/or DNAI(s) and/or application(s)]] may be managed.
[[Editor's note: It is FFS whether it is needed and how to support the feature related with “caching timer’ and ‘Allow Delay’.]]
. . .

### 6.2.3.4.x EAS Deployment Information Management Via the NEF

. . .

### FIG. 6.2.3.4.x-1: EAS Deployment Information Management in the AF Procedure

1. The AF invokes the Nnef EASDeployment Create/Update/Delete service. Either AF Service Identifier or the combination of DNN and S-NSSAI shall be provided in the Create operation. The Allowed Delay is an optional parameter which indicates that the EAS deployment information should be provisioned within the time interval indicated by the Allowed Delay to the SMF(s) that have subscribed to the EAS deployment management service using Nnef EASDeployment Subscribe service operation.
2. NEF checks whether the AF is authorized to perform this request. The NEF invokes the Nudr DM Create/Update/Delete to the UDR if it is authorized. The NEF derives DNN and S-NSSAI from the AF Service Identifier if not received explicitly and translates received External Application Identifier to Application Identifier known inside MNO domain.
3. The UDR stores/updates/removes the corresponding information (Application Identifier, DNN, S-NSSAI, DNAI(s), list of FQDNs supported by the application and EAS IP address ranges per DNAI, Allowed Delay) and responds a Nudr DM Create/Update/Delete Response to the NEF.
4. The NEF responds Nnef EASDeployment Create/Update/Delete Response to the AF.

### 7.x NEF Services

### 7.x.1 General

The following table illustrates the NEF Services and Service Operations.

TABLE 7.x.1-1
NF services provided by the NEF

| | Service | Operation | Example |
|---|---|---|---|
| Service Name | Operations | Semantics | Consumer(s) |
| Nnef_EASDeployment | Create | Request/Response | AF |
| | Update | Request/Response | AF |
| | Delete | Request/Response | AF |
| | Subscribe | Subscribe/Notify | SMF |
| | Unsubscribe | | SMF |
| | Notify | | SMF |

### 7.x.2 Nnef EASDeployment Service

### 7.x.2.1 General

Service description: This service enables the consumer to create, update, or delete the EAS deployment information.

### 7.x.2.2 Nnef EASDeployment Create Service Operation

Service operation name: Nnef EASDeployment Create.
Description: Create EAS deployment information in NEF.
Input, Required: External Application Identifier, AF Service Identifier or Combination of DNN and S-NSSAI, list of FQDN(s), list of DNAI(s), L-DNS IP address and port per DNAI and EAS IP address ranges per DNAI.
Input, Optional: Allowed Delay.
Output, Required: Result, Transaction Reference ID.
Output, Optional: None.

### 7.x.2.3 Nnef EASDeployment Update Service Operation

Service operation name: Nnef EASDeployment Update.
Description: Update the EAS deployment information in NEF.
Input, Required: Transaction Reference ID, External Application Identifier, list of FQDN(s), list of DNAI(s), L-DNS IP address and port per DNAI and EAS IP address ranges per DNAI.
Input, Optional: Allowed Delay.
Output, Required: Result.
Output, Optional: None.

### 7.x.2.4 Nnef EASDeployment Delete Service Operation

Service operation name: Nnef EASDeployment_Delete.
Description: Delete the EAS deployment information in NEF.
Input, Required: Transaction Reference ID.
Input, Optional: None.
Output, Required: Result.
Output, Optional: None.

### 7.x.2.5 Nnef EASDeployment Subscribe Service Operation

Service operation name: Nnef_EASDeployment Subscribe.
Description: provided by the NEF for NF consumers to explicitly subscribe the notification of changes of EAS deployment information.
Input, Required: Application Identifier(s), Immediate Report Indication, Notification Target Address.
Input, Optional: list of DNAI(s), DNN and S-NSSAI.
Output, Required: Result, Subscription Correlation ID (if result is successful).
Output, Optional: None.

### 7.x.2.6 Nnef EASDeployment Unsubscribe Service Operation

Service operation name: Nnef EASDeployment_Unsubscribe.
Description: Provides by the NEF for NF Consumer to explicitly unsubscribe the notification of changes of EAS deployment information.
Input, Required: Subscription Correlation ID.
Input, Optional: None.
Output, Required: Result.
Output, Optional: None.

### 7.x.2.7 Nnef EASDeployment Notify Service Operation

Service operation name: Nnef EASDeployment_Notify.
Description: Provides by the NEF to notify NF Consumer with the EAS deployment information.
Input, Required: Notification Correlation Information, EAS deployment information.
Input, Optional: None.
Output, Required: Result.
Output, Optional: None.
EAS Deployment information consists of Application Identifier(s), list of FQDNs, list of DNAIs, L-DNS IP address and port per DNAI, EAS IP address ranges per DNAI, DNN and S-NSSAI.

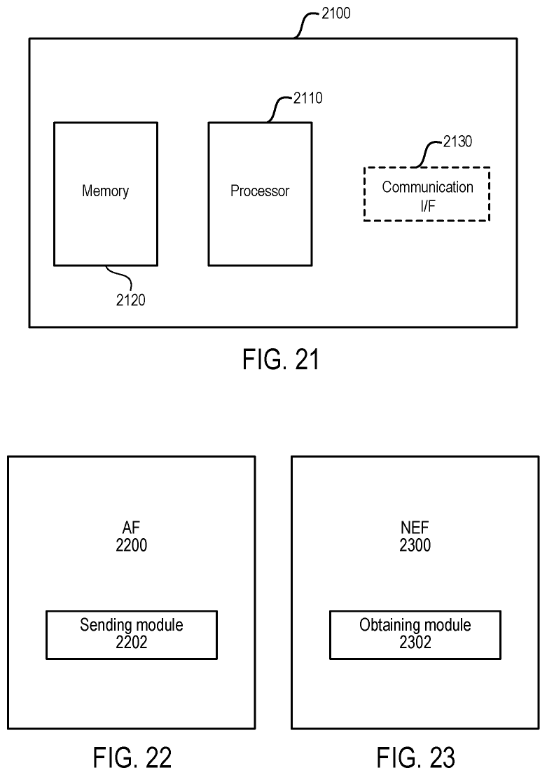

FIG. 21 is a block diagram showing an apparatus suitable for use in practicing some embodiments of the disclosure. For example, any one of the AF, NEF, UDR, PCF, SMF, service consumer and NEF described above may be implemented through the apparatus 2100. As shown, the apparatus 2100 may include a processor 2110, a memory 2120 that stores a program, and optionally a communication interface 2130 for communicating data with other external devices through wired and/or wireless communication.

The program includes program instructions that, when executed by the processor 2110, enable the apparatus 2100 to operate in accordance with the embodiments of the present disclosure, as discussed above. That is, the embodiments of the present disclosure may be implemented at least in part by computer software executable by the processor 2110, or by hardware, or by a combination of software and hardware.

The memory 2120 may be of any type suitable to the local technical environment and may be implemented using any suitable data storage technology, such as semiconductor based memory devices, flash memories, magnetic memory devices and systems, optical memory devices and systems, fixed memories and removable memories. The processor 2110 may be of any type suitable to the local technical environment, and may include one or more of general purpose computers, special purpose computers, microprocessors, digital signal processors (DSPs) and processors based on multi-core processor architectures, as non-limiting examples.

FIG. 22 is a block diagram showing an AF according to an embodiment of the disclosure. As shown, the AF 2200 comprises a sending module 2202 configured to send, to an NEF or a PCF, an indicator indicating whether an application associated with the AF requires EAS discovery supported by EASDF.

FIG. 23 is a block diagram showing an NEF according to an embodiment of the disclosure. As shown, the NEF 2300 comprises an obtaining module 2302 configured to obtain an indicator indicating whether an application associated with an AF requires EAS discovery supported by EASDF.

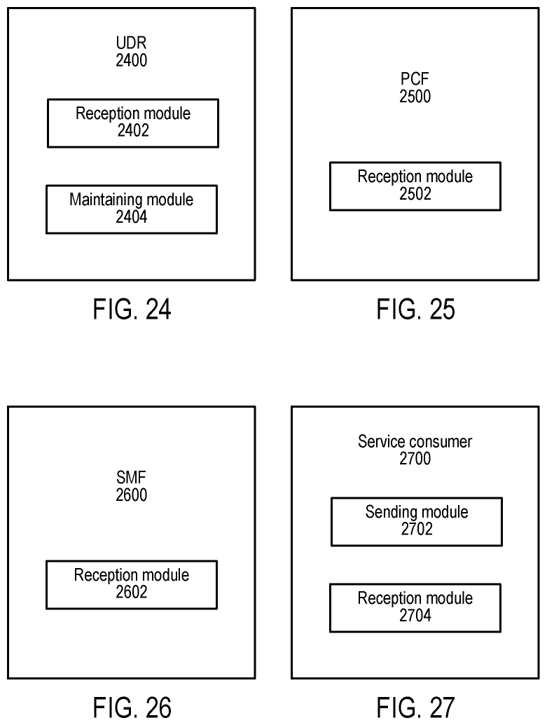

FIG. 24 is a block diagram showing a UDR according to an embodiment of the disclosure. As shown, the UDR 2400 comprises a reception module 2402 and a maintaining module 2404. The reception module 2402 may be configured to receive, from an NEF, an indicator indicating whether an application associated with an AF requires EAS discovery supported by EASDF. The maintaining module 2404 may be configured to maintain the received indicator.

FIG. 25 is a block diagram showing a PCF according to an embodiment of the disclosure. As shown, the PCF 2500 comprises a reception module 2502 configured to receive, from a UDR or an AF or an NEF, an indicator indicating whether an application associated with the AF requires EAS discovery supported by EASDF.

FIG. 26 is a block diagram showing an SMF according to an embodiment of the disclosure. As shown, the SMF 2600 comprises a reception module 2602 configured to receive, from a PCF, an indicator indicating whether an application associated with an AF requires EAS discovery supported by EASDF.

FIG. 27 is a block diagram showing a service consumer according to an embodiment of the disclosure. As shown, the service consumer 2700 comprises a sending module 2702 and a reception module 2704. The sending module 2702 may be configured to send, to an NEF, a request for performing an operation related to EAS deployment information for an application. The reception module 2704 may be configured to receive, from the NEF, a response to the request.

For example, the service consumer 2700 may be an AF. The sending module 2702 of the AF 2700 may be configured to send, to an NEF, a request for performing an operation related to EAS deployment information for an application. The request is for creating, or updating, or deleting EAS deployment information. The reception module 2704 of the AF 2700 may be configured to receive, from the NEF, a response to the request.

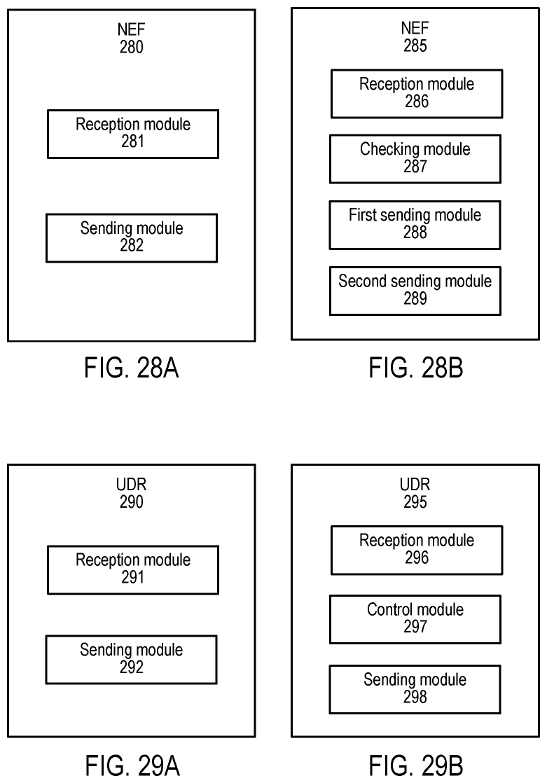

FIG. 28A is a block diagram showing an NEF according to an embodiment of the disclosure. As shown, the NEF 280 comprises a reception module 281 and a sending module 282. The reception module 281 may be configured to receive, from a service consumer, a request for performing an operation related to EAS deployment information for an application. The sending module 282 may be configured to send, to the service consumer, a response to the request.

FIG. 28B is a block diagram showing an NEF according to an embodiment of the disclosure. As shown, the NEF 285 comprises a reception module 286, a checking module 287, a first sending module 288 and a second sending module 289. The reception module 286 may be configured to receive, from an AF, a request for performing an operation related to EAS deployment information for an application. The request is for creating, or updating, or deleting EAS deployment information. The checking module 287 may be configured to check whether the AF is authorized to perform the request. The first sending module 288 may be configured to, if the AF is authorized, send, to a UDR, another request for creating, or updating, or deleting EAS deployment information. The second sending module 289 may be configured to send, to the AF, a response to the request.

FIG. 29A is a block diagram showing a UDR according to an embodiment of the disclosure. As shown, the UDR 290 comprises a reception module 291 and a sending module 292. The reception module 291 may be configured to receive, from an NEF, a request for performing an operation related to EAS deployment information for an application. The sending module 292 may be configured to send, to the NEF, a response to the request.

FIG. 29B is a block diagram showing a UDR according to an embodiment of the disclosure. As shown, the UDR 295 comprises a reception module 296, a control module 297 and a sending module 298. The reception module 296 may be configured to receive, from an NEF, a request for performing an operation related to EAS deployment information for an application. The request is for creating, or updating, or deleting EAS deployment information for the application. The control module 297 may be configured to store or update or remove the corresponding EAS deployment information in response to the request from the NEF. The sending module 298 may be configured to send, to the NEF, a response to the request. The modules described above may be implemented by hardware, or software, or a combination of both.

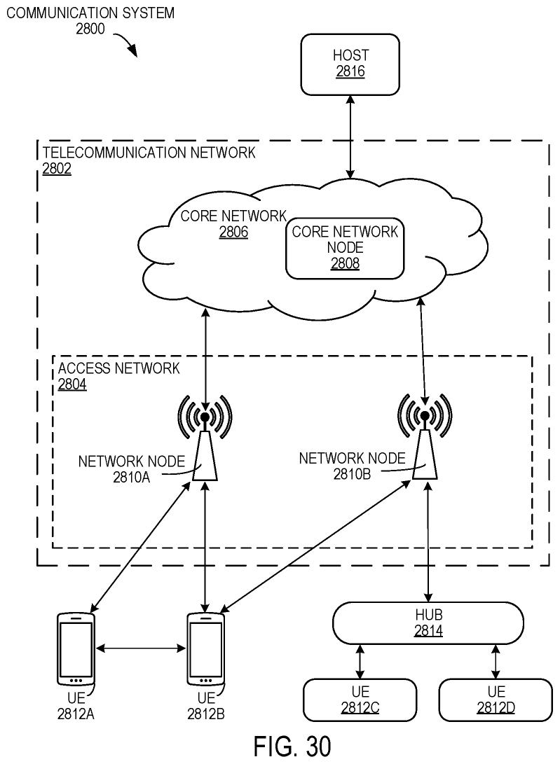

FIG. 30 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 30 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (cMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

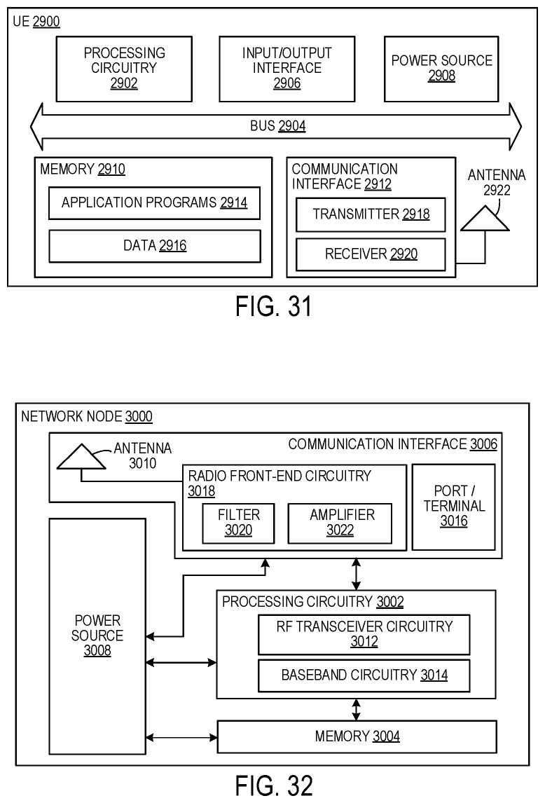

FIG. 31 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 31. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 31.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 32 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 32 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

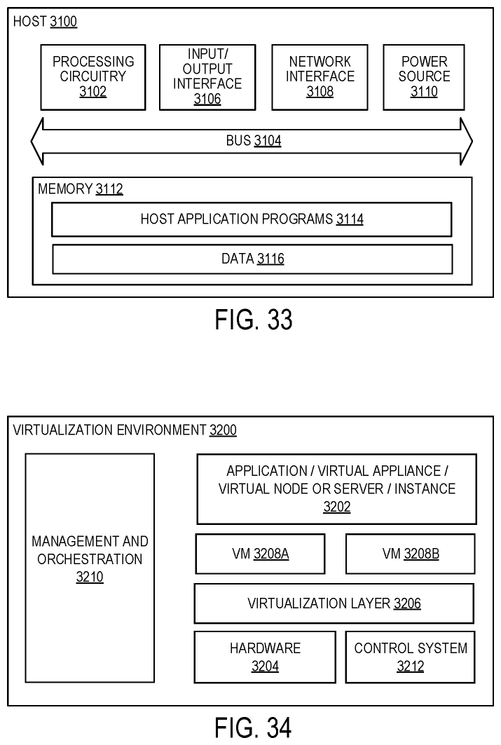

FIG. 33 is a block diagram of a host 3100, which may be an embodiment of the host 2816 of FIG. 30, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 31 and 32, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 34 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

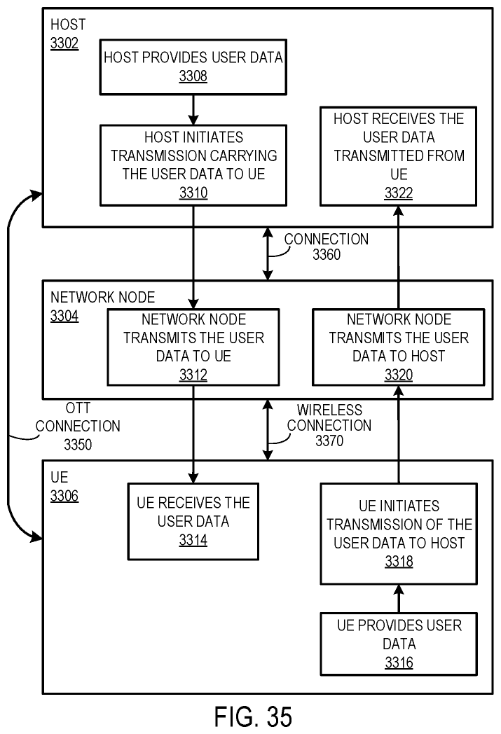

FIG. 35 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 30 and/or UE 2900 of FIG. 31), network node (such as network node 2810a of FIG. 30 and/or network node 3000 of FIG. 32), and host (such as host 2816 of FIG. 30 and/or host 3100 of FIG. 33) discussed in the preceding paragraphs will now be described with reference to FIG. 35.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 30) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the resource utilization and thereby provide benefits such as more valid throughput.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by an application function, AF, comprising:
sending, to a network exposure function, NEF, a request for performing an operation related to edge application server, EAS, deployment information for an application, wherein the request is for creating, or updating, or deleting EAS deployment information; and
receiving, from the NEF, a response to the request.

2. The method according to claim 1, wherein the request is an Nnef_EASDeployment_Create/Update/Delete Request.

3. A method performed by a network exposure function, NEF, comprising:
receiving, from an application function, AF, a request for performing an operation related to edge application server, EAS, deployment information for an application, wherein the request is for creating, or updating, or deleting EAS deployment information;
checking whether the AF is authorized to perform the request;
if the AF is authorized, sending, to a User Data Repository, UDR, another request for creating, or updating, or deleting EAS deployment information; and
sending, to the AF, a response to the request.

4. The method according to claim 3, wherein the request is an Nnef_EASDeployment_Create/Update/Delete Request.

5. The method according to claim 3, further comprising:
receiving, from a Session Management Function, SMF, a Nnef_EASDeployment_Subscribe request for subscribing the EAS deployment information change notification, wherein the request indicates that current status of the EAS deployment information shall be notified immediately.

6. The method according to claim 5, further comprising:
sending, to the SMF, a Nnef_EASDeployment_Notify message including the EAS deployment information.

7. A method performed by a user data repository, UDR, comprising:
receiving, from a network exposure function, NEF, a request for performing an operation related to edge application server, EAS, deployment information for an application, wherein the request is for creating, or updating, or deleting EAS deployment information for the application;
storing or updating or removing the corresponding EAS deployment information in response to the request from the NEF; and
sending, to the NEF, a response to the request.

8. The method according to claim 7, wherein the request is an Nudr_DM_Create/Update/Delete Request.

9. An application function, AF, comprising:
at least one processor; and
at least one memory, the at least one memory; containing instructions executable by the at least one processor, whereby the AF is operative to:
send, to a network exposure function, NEF, a request for performing an operation related to edge application server, EAS, deployment information for an application, wherein the request is for creating, or updating, or deleting EAS deployment information; and
receive, from the NEF, a response to the request.

10. The AF according to claim 9, wherein the request is an Nnef_EASDeployment_Create/Update/Delete Request.

11. A network exposure function, NEF, comprising:
at least one processor; and
at least one memory, the at least one memory containing instructions executable by the at least one processor, whereby the NEF is operative to:
receive, from an application function, AF, a request for performing an operation related to edge application server, EAS, deployment information for an application, wherein the request is for creating, or updating, or deleting EAS deployment information;
check whether the AF is authorized to perform the request;
if the AF is authorized, send, to a User Data Repository, UDR, another request for creating, or updating, or deleting EAS deployment information; and
send, to the AF, a response to the request.

12. The NEF according to claim 11, wherein the request is an Nnef_EASDeployment_Create/Update/Delete Request.

13. A user data repository, UDR, comprising:
at least one processor; and
at least one memory, the at least one memory containing instructions executable by the at least one processor, whereby the UDR is operative to:
receive, from a network exposure function, NEF, a request for performing an operation related to edge application server, EAS, deployment information for an application, wherein the request is for creating, or updating, or deleting EAS deployment information for the application;
store or update or remove the corresponding EAS deployment information in response to the request from the NEF; and
send, to the NEF, a response to the request.

14. The UDR according to claim 13, wherein the request is an Nudr_DM_Create/Update/Delete Request.

15. (canceled)

16. The NEF according to claim 11, further operative to:
receive, from a Session Management Function, SMF, a Nnef_EASDeployment_Subscribe request for subscribing the EAS deployment information change notification, wherein the request indicates that current status of the EAS deployment information shall be notified immediately.

17. The NEF according to claim 11, further operative to:
send, to the SMF, a Nnef_EASDeployment_Notify message including the EAS deployment information.
